(19) United States
(12) Patent Application Publication
(10) Pub. No.: US 2016/0026765 A1
(43) Pub. Date: Jan. 28, 2016

(54) IMMUNOTHERAPY SYSTEM AND METHOD THEREOF

(71) Applicant: PHD PREVENTIVE HEALTH CARE AND DIAGNOSTICS, INC., Colorado Springs, CO (US)

(72) Inventors: Eric R. DAINES, Colorado Springs, CO (US); Anthony J. VECCHIARELLI, Colorado Springs, CO (US); Bruce M. BERNSTEIN, Colorado Springs, CO (US)

(73) Assignee: PHD Preventative Health Care and Diagnostics, Inc., Colorado Springs, CO (US)

(21) Appl. No.: 14/775,706

(22) PCT Filed: Mar. 17, 2014
(86) PCT No.: PCT/US2014/030743

§ 371 Date: Sep. 13, 2015

Related U.S. Application Data
(60) Provisional application No. 61/798,011, filed on Mar. 15, 2013.

(51) Int. Cl. G06F 19/00

(52) U.S. Cl. CPC G06F 19/345; G06F 19/322

(57) ABSTRACT

An aspect of the invention generally relates to an immunotherapy system and method thereof, and more particularly to a method and system for providing, generating, tracking an immunotherapy treatment.

The present application claims the benefit of U.S. Provisional Patent Application No. 61/798,011 filed on Mar. 15, 2013, which is herein incorporated by reference in its entirety.

### BACKGROUND OF THE INVENTION

### Field of the Invention

The present invention generally relates to an immunotherapy system and method thereof, and more particularly to a method and system for providing, generating and tracking an immunotherapy treatment.

### SUMMARY OF THE INVENTION

Accordingly, the invention is directed to an immunotherapy system and method that substantially obviates one or more of the problems due to limitations and disadvantages of the related art.

An advantage of the invention is to provide an automated system and method.

Yet another advantage of the invention is narrow it down all tested allergens to the 5 most likely allergens to be causing symptoms as it is thought that treating for fewer allergens is more efficacious than treating for everything the patient is allergic to.

Still yet another advantage of the invention is to provide a system for providers to aid in analyzing test results and providing a treatment recommendation.

To achieve these and other advantages and in accordance with the purpose of the present invention, as embodied and broadly described, in one embodiment, a method for generating a patient specific immunotherapy treatment recommendation at one or more devices that includes receiving, from one or more locations, a first input comprising information indicative of a patient medical history, a second input comprising information having characteristics indicative of one or more science factors, a third input comprising information having characteristics indicative of a patient's immune response to one or more antigens of a test; and generating, using a processor, an immunotherapy treatment recommendation based on the first input, the second input and the third input.

In another embodiment, a system for generating a patient specific immunotherapy treatment recommendation that includes a network interface configured to receive a first input, second input and third input. A first input includes information having characteristics indicative of a patient's medical history, a second input includes information having characteristics indicative of one or more science factors, and a third input includes information having characteristics indicative of a patient's immune response to one or more antigens of a test. The system, e.g., a processor on one or more of a server, patient device or provider device are configured to process the first input, the second input and the third input to determine an immunotherapy treatment recommendation.

In still yet another, a computer device includes at least one processor and at least one memory. The at least one processor and the at least one memory are communicatively arranged to generate an immunotherapy treatment recommendation from one or more inputs received from a provider device comprising at least one processor and at least one memory, provide the immunotherapy treatment recommendation to the provider device, and receive a verification of the immunotherapy treatment recommendation from the provider device.

In another embodiment, an immunotherapy system includes a provider device and a server. The provider device includes at least one processor and at least one memory and the server includes at least one processor and at least one memory configured to generate an immunotherapy treatment recommendation from one or more inputs received from the provider device over a network. The server is configured to provide the immunotherapy treatment recommendation to the provider device over the network and the server is configured to receive a verification of the immunotherapy treatment recommendation from the provider device over the network.

In yet another embodiment, a computer-readable storage medium tangibly embodying a program of instructions executable by a machine includes a plurality of program code to implement processes described herein. In a preferred embodiment, the program code includes program instruction including a plurality of program codes for managing immunotherapy. The program instructions include program code for generating an immunotherapy treatment recommendation with a server, program code for providing the immunotherapy treatment recommendation to a provider device and program code for receiving a verification of the immunotherapy treatment recommendation from the provider device.

In still another embodiment, a cloud based storage medium tangibly embodies a program of instructions executable by a machine wherein said program of instruction comprises a plurality of program codes for managing immunotherapy. The program instructions include program code for generating an immunotherapy treatment recommendation with a server, program code for providing the immunotherapy treatment recommendation to a provider device, and program code for receiving a verification of the immunotherapy treatment recommendation from the provider device.

In yet another embodiment, a method for providing immunotherapy treatment recommendations to a medical provider includes generating an immunotherapy treatment recommendation with a provider device. The method also includes providing the immunotherapy treatment recommendation to the provider device and receiving a verification of the immunotherapy treatment recommendation from the provider device.

It is understood that this Summary section is neither intended to be, nor should be, construed as being representative of the full extent and scope of the present disclosure. Additional benefits, features and embodiments of the present disclosure are set forth in the attached figures and in the description herein below, and as described by the claims. Accordingly, it should be understood that this Summary section may not contain all of the aspects and embodiments claimed herein.

Additionally, the disclosure herein is not meant to be limiting or restrictive in any manner. Moreover, the present disclosure is intended to provide an understanding to those of ordinary skill in the art of one or more representative embodiments supporting the claims. Thus, it is important that the claims be regarded as having a scope including constructions of various features of the present disclosure insofar as they do not depart from the scope of the methods and apparatuses consistent with the present disclosure (including the originally filed claims). Moreover, the present disclosure is intended to encompass and include obvious improvements and modifications of the present disclosure.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 illustrates an exemplary block diagram of an immunotherapy system according to an embodiment of the invention;

FIG. 2 illustrates an exemplary block diagram of a patient device according to an embodiment of the invention;

FIG. 3 illustrates an exemplary block diagram of a provider device according to an embodiment of the invention;

FIG. 4 illustrates an exemplary block diagram of a process conducted with the system according to an embodiment of the invention;

FIG. 5 illustrates an exemplary block diagram of generating an immunotherapy treatment recommendation conducted with the system according to an embodiment of the invention;

FIG. 6 illustrates an exemplary block diagram of generating an immunotherapy treatment recommendation conducted with the system according to an embodiment of the invention;

FIG. 7 illustrates an exemplary block diagram of ranking allergens of an allergen treatment data set conducted with the system according to an embodiment of the invention;

FIG. 8 illustrates an exemplary block diagram of adjusting the ranking of allergens in an allergen treatment data set conducted with the system based on an allergy questionnaire according to an embodiment of the invention;

FIG. 9 illustrates an exemplary block diagram of adjusting the ranking of allergens in an allergen treatment data set conducted with the system based on geographical considerations according to an embodiment of the invention;

FIG. 10 illustrates an exemplary block diagram of adjusting the ranking of allergens in an allergen treatment data set conducted with the system based on other predetermined criteria according to an embodiment of the invention;

FIG. 11 illustrates an exemplary block diagram of adjusting ranking of allergens in an allergen treatment data set conducted with the system based on priority codes according to an embodiment of the invention;

FIG. 12 illustrates an exemplary block diagram of receiving a verification of a treatment recommendation conducted with the system according to an embodiment of the invention;

FIG. 13 illustrates an exemplary block diagram of a compliance module conducted with the system according to an embodiment of the invention;

FIG. 14 illustrates an exemplary block diagram of an injection module with a specific treatment conducted with the system according to an embodiment of the invention;

FIG. 15 illustrates an exemplary block diagram of an authorization, output and/or update module conducted with the system according to an embodiment of the invention;

FIG. 16 illustrates an exemplary screen shot allergy test form prior to receiving results according to an embodiment of the invention;

FIG. 17 illustrates an exemplary screen shot of an allergy final treatment recommendation prior according to an embodiment of the invention;

FIG. 18 illustrates an exemplary screen shot of a patient diagnosis form including an allergy questionnaire screen according to an embodiment of the invention;

FIG. 19 illustrates an exemplary screen shot an allergy questionnaire form according to an embodiment of the invention;

FIG. 20 illustrates an exemplary screen shot of a patient compliance form according to an embodiment of the invention;

FIG. 21 illustrates an exemplary screen shot of a patient waiver and release form according to an embodiment of the invention; and

FIG. 22 illustrates an exemplary screen shot of a patient treatment schedule according to an embodiment of the invention.

### DETAILED DESCRIPTION OF THE ILLUSTRATED EMBODIMENTS

Reference will now be made in detail to an embodiment of the present invention, example of which is illustrated in the accompanying drawings.

Functional units described in this specification and figures may be labeled as modules, or outputs in order to more particularly emphasize their structural features. A module and/or output may be implemented as hardware, e.g., comprising circuits, gate arrays, off-the-shelf semiconductors such as logic chips, transistors, or other discrete components. They may be fabricated with Very-large-scale integration (VLSI) techniques. A module and/or output may also be implemented in programmable hardware such as field programmable gate arrays, programmable array logic, programmable logic devices or the like. Modules may also be implemented in software for execution by various types of processors. In addition, the modules may be implemented as a combination of hardware and software in one embodiment.

An identified module of programmable or executable code may, for instance, include one or more physical or logical blocks of computer instructions which may, for instance, be organized as an object, procedure, or function. Components of a module need not necessarily be physically located together but may include disparate instructions stored in different locations which, when joined logically together, include the module and achieve the stated function for the module. The different locations may be performed on a network, patient device, provider device, server and combinations of one or more the same. A module and/or a program of executable code may be a single instruction, or many instructions, and may even be distributed over several different code segments, among different programs, and across several memory devices. Similarly, data or input for the execution of such modules may be identified and illustrated herein as being an encoding of the modules, or being within modules, and may be embodied in any suitable form and organized within any suitable type of data structure.

In one embodiment, the system, components and/or modules discussed herein may include one or more of the following: a server or other computing systems including a processor for processing digital data, memory coupled to the processor for storing digital data, an input digitizer coupled to the processor for inputting digital data, an application program stored in one or more machine data memories and accessible by the processor for directing processing of digital data by the processor, a display device coupled to the processor and memory for displaying information derived from digital data processed by the processor, and a plurality of databases or data management systems.

In one embodiment, functional block components, screen shots, user interaction descriptions, optional selections, various processing steps, and the like are implemented with the system. It should be appreciated that such descriptions may be realized by any number of hardware and/or software components configured to perform the functions described. Accordingly, to implement such descriptions, various integrated circuit components, e.g., memory elements, processing elements, logic elements, look-up tables, input-output devices, displays and the like may be used, which may carry out a variety of functions under the control of one or more microprocessors or other control devices.

In one embodiment, software elements may be implemented with any programming, scripting language, and/or software development environment, e.g., Fortran, C, C++, C#, COBOL, Apache Tomcat, Spring Roo, Web Logic, Web Sphere, assembler, PERL, Visual Basic, SQL, SQL Stored Procedures, AJAX, extensible markup language (XML), Flex, Flash, Java, .Net and the like. Moreover, the various algorithms in the embodiments may be implemented with any combination of data structures, objects, processes, routines or other programming elements.

In one embodiment, any number of conventional techniques for data transmission, signaling, data processing, network control, and the like as one skilled in the art will understand may be used. Further, detection or prevention of security issues using various techniques known in the art, e.g., encryption, may be also be used in embodiments of the invention. Additionally, many of the functional units and/or modules, e.g., shown in the figures, may be described as being “in communication” with other functional units and/or modules. Being “in communication” refers to any manner and/or way in which functional units and/or modules, such as, but not limited to, input/output devices, computers, laptop computers, PDAs, mobile devices, smart phones, modules, and other types of hardware and/or software may be in communication with each other. Some non-limiting examples include communicating, sending and/or receiving data via a network, a wireless network, software, instructions, circuitry, phone lines, Internet lines, fiber optic lines, satellite signals, electric signals, electrical and magnetic fields and/or pulses, and/or the like and combinations of the same.

By way of example, communication among the users, subscribers and/or server in accordance with embodiments of the invention may be accomplished through any suitable communication channels, such as, for example, a telephone network, an extranet, an intranet, the Internet, cloud based communication, point of interaction devices (point of sale device, personal digital assistant, cellular phone, kiosk, and the like), online communications, off-line communications, wireless communications, RF communications, cellular communications, Wi-Fi communications, transponder communications, local area network (LAN) communications, wide area network (WAN) communications, networked or linked devices and/or the like. Moreover, although embodiments of the invention may be implemented with TCP/IP communications protocols, other techniques communications may also be implemented using IEEE protocols, IPX, Appletalk, IP-6, NetBIOS, OSI or any number of existing or future protocols. Specific information related to the protocols, standards, and application software utilized in connection with the Internet is generally known to those skilled in the art and, as such, need not be detailed herein.

In embodiments of the invention, the system provides and/or receives a communication or notification via the communication system to or from an end user. The communication is typically sent over a network, e.g., a communication network. The network may utilize one or more of a plurality of wireless communication standards, protocols or wireless interfaces (including LTE, CDMA, WCDMA, TDMA, UMTS, GSM, GPRS, OFDMA, WiMAX, FLO TV, Mobile DTV, WLAN, and Bluetooth technologies), and may be provided across multiple wireless network service providers. The system may be used with any mobile communication device service (e.g., texting, voice calls, games, videos, Internet access, online books, etc.), SMS, MMS, email, mobile, land phone, tablet, smartphone, television, vibrotactile glove, voice carry over, video phone, pager, relay service, teletypewriter, and/or GPS and combinations of the same.

One embodiment is directed towards a system for generating an immunotherapy treatment recommendation. Immunotherapy is a treatment of disease by inducing, enhancing, or suppressing an immune response. Immunotherapies that are designed to elicit or amplify an immune response are classified as activation immunotherapies, while immunotherapies that reduce or suppress an immune response are classified as suppression immunotherapies. In one embodiment, the immunotherapy treatment recommendation is configured to be administered, at least in part, with allergy shots, allergy oral treatments, and/or other allergy treatment mechanisms. The treatment is configured help a patient's body become accustomed to allergens, the things that trigger an allergic reaction. Treatment with allergy shots can eventually end or minimize symptoms as a patient's body will get used to allergens and may not have allergic reactions as often. An allergen, protein antagonist or antigen, which are used interchangeably herein, is any substance that can cause an allergy. An allergen extract is a concentrated form of the allergen. Alternatively and/or optionally, the generate treatment recommendation module provides specific information configured for configuring the allergens for treating a specific patient with an efficacious home based immunotherapy. The allergens, e.g., one to five or more, are provided in various concentrations as one treatment set and used by a patient in a home based immunotherapy program.

In one embodiment, the system and/or method are configured to deduce at of all the tested allergens to the five (5) most likely allergens to be causing symptoms to a patient out of the allergen tested. The allergens tested may include 50 or more allergens, in a preferred embodiment, 60 allergens are tested on the patient. It is thought that treating for fewer allergens is more efficacious than treating for everything the patient had a reaction; thereby the system and method are thought to provide a highly efficacious treatment.

In one embodiment, the immunotherapy treatment recommendation includes a treatment recommendation with one or more allergen to be administered to a patient over a predetermined time, e.g., 1 allergen, 2 allergens, 3 allergens, 4 allergens, 5 allergens, 6 allergens, 7 allergens, 8 allergens, 9 allergens, 10 allergens or more. More preferably, 5 allergens make up the treatment recommendation. The allergens may be the same or different. The predetermined treatment time may be up to one year or more with changing concentrations of the treatments with changing concentrations. In a preferred embodiment, the allergen extract is a liquid solution including one or more allergenic proteins from pollens, dust mites, animal dander, molds and insects. The concentrate may be in the form of aqueous, glycerinated, lyophilized, acetone precipitated, and alum precipitated.

In one embodiment, the treatment set includes various concentrations of allergens mixed together, e.g., 2 or more allergens in treatment delivery containers at various concentrations for administering. In a preferred embodiment, the concentration of the non-diluted allergens depends on the manufacturer and lot. In one embodiment, the chosen allergens are mixed in a one-to-one mixture to obtain the concentrate. That is, if 5 allergens are generated in the treatment set, each of these allergens may have different initial concentration for the manufacturer, but the concentrate mixture set are mixed as one to one. In one embodiment, an efficacious and safe concentration of the treatment increases over time per a schedule provided by the system, which may be, e.g., 1:5000 dilution, 1:500 dilution, 1:50 dilution, and 1:5 dilution. These are administered by a patient, provider and combinations of the same according to a schedule generated by the system. The schedule is dynamic which permits a user to update, change, eliminate, adjust and/or monitor the schedule either manually, automatically or both. In one embodiment, an injection device is configured with sensors and communication hardware and software to provide automatic updates to the system at each injection, thereby updating the schedule.

In a preferred embodiment, the first schedule is a ramping schedule, that may be a predetermined time frame from about 1 week to 6 weeks or greater, preferably 6 weeks. In this embodiment, a pretreatment injection of about 0.04 ml is administered with the injection device or other instrument at a provider's office by the provider or patient. Next, the ramp is started at a 1:5000 dilution according to the first schedule which could be used as follows: Week 1: shot 1—0.06 mL, 5000 dilution, shot 2—0.09 mL, 5000 dilution; Week 2: shot 1—0.12 mL, 5000 dilution, shot 2—0.15 mL, 5000 dilution; Week 3: shot 1—0.18 mL, 5000 dilution, shot 2—0.21 mL, 5000 dilution; Week 4: shot 1—0.24 mL, 5000 dilution, shot 2—0.27 mL, 5000 dilution; Week 5: shot 1—0.30 mL, 5000 dilution, shot 2—0.33 mL, 5000 dilution; Week 6: shot 1—0.36 mL, 5000 dilution, shot 2—0.39 mL, 5000 dilution. Next, the concentration is adjusted and a new schedule is utilized to increase to a mixture with a starting concentration of 1:500 vol/vol or 500 dilution and a six week treatment set is repeated; however, the starting point is not 0.03 mL, but 0.06 mL, therefore the ending point in week six is 0.39 mL. This is repeated for the rest of the concentrations in six week increments until the 1.5 vol/vol or 5 dilution is given in the six week ramp treatment. Next a maintenance schedule is given for about six months or longer. The maintenance schedule is linear and two shots per week at volume in a range from about 0.30 mL to about 0.39 mL are given, that is, the volume doesn't change, but is constant for the entire maintenance. There is no change in volume from week to week or concentration from week to week or shot to shot. The amount of volume change between shots and durations of schedules is dependent on the efficacy and safety of the immunotherapy and may be adjusted to stay within the efficacy and safety bounds as known in the art.

The treatments can be provided with an injection device, standard needle device, needle-free device or orally by a provider, user or both. In one embodiment, the injection device is a needle-free injector as described with reference to any patent and patent application publication herein including but not limited to U.S. Pat. Nos. 5,104,380; 7,547,293; 7,618,393; 7,699,802; 8,529,500 and U.S. Patent Application Publication Nos. 2007/0027428; 2013/0035634; 2013/0150820; and 2014/00632, each of which are hereby incorporated by reference as if fully set forth herein. Optionally, the cartridge includes a chamber as described with reference to any patent described herein including but not limited to U.S. Pat. Nos. 5,104,380; 7,547,293; 7,618,393; 7,699,802; 8,529,500 and U.S. Patent Application Publication Nos. 2007/0027428; 2013/0035634; 2013/0150820; and 2014/00632, each of which are hereby incorporated by reference as if fully set forth herein. Moreover, the geometry of the cartridge may be configured to fit within any injection device as known in the art. The cartridge may include any materials, e.g., glass, plastic, metal, alloy, composite materials, thermoplastic, tempered glass and combinations thereof. The cartridge may also be transparent, semitransparent or not transparent to light. Alternately and/or optionally, the container includes a material selected from the group consisting of glass, plastic, thermoplastic, tempered glass, metal, alloy, composite, and combinations thereof.

In one embodiment, an allergy treatment recommendation module is configured to generate a specific treatment by programmatically deducing an immunotherapy treatment recommendation based on one or more of the patient's history, science factors, and results from the allergy test. The immunotherapy treatment recommendation includes one or more allergens configured to elicit an immune response. In a preferred embodiment, the allergens are classified into broad categories based on transmission or other functional characteristics of the allergens. For example, the first category is called a vector group, and includes a pollen vector group, an animal vector group, a control vector group and an environment vector group.

In addition, these vector groups can have a further classification of allergens into sub-vector groups below each vector group. For example, the pollen vector group includes a tree sub-vector group, a grass sub-vector group, a weed sub-vector group, a plant sub-vector group and other pollen transmitting sub-vector groups. The animal vector group includes an indoor animal sub-vector group and an outdoor animal sub-vector group. The control vector group includes a saline control sub-vector group and histamine control sub-vector group. The environmental vector group includes a mold sub-vector group and cockroach allergens. Optionally and/or alternatively, the allergens within each sub-vector group may be further classified into one or more of seasons, amount of pollen produced per a predetermined time of one or more plant, tree, weed, or grass associated with each a specific vector group, sub-vector group or both, a cross-reactivity designation of one or more antigens in each sub-vector group, a frequency designation of one or more plant, tree, weed, or grass associated with each a specific vector group, sub-vector group or both per a predetermined area, and a meteorological factors associated with one or more plant, tree, weed, or grass associated with each a specific vector group, sub-vector group.

In one embodiment, the tree sub-vector group includes one or more allergens, e.g., an Acacia, Golden (Acacia longifolia); Alder, Red (alnus rubra (oregona)); Ash, White (Faxinus grandifolia); Beech, American (Fagus grandifolia); Birch Mix (Paper, River/Red & White Birch); Boxelder/Maple Mix (Boxelder, Hard Maple & Red Maple); Cedar, Mountain (Jumperus ashei); Cedar, Red (Juniperus virginiana); Cottonwood, Common (Populus deltoides); Cypress, Arizona (Curpressus arizonica); Cypress, Bald (Taxodium distichum); Elm, American (Ulmus americana); Elm, Chinese (Ulmus parvifolia); Eucalyptus/Blue Gum (Eucalyptus globulus); Gum, Sweet (Liquidambar styraciflua); Hackberry (Celtis occidentalis); Hickory, Shagbark (Carya ovata); Linden/Basswood (Tilia americana); Maple, Hard/Sugar (Acer saccharum); Mesquite (Prosopis juliflora (glandulosa)); Mulberry Mix (Red & White Mulberry); Oak, Red (Quercus rubra); Oak Mix (Red, Virginia Live & White Oak); Olive Tree (Olea europaea); Bottlebrush Tree (Callistemon citrinus); Melaleuca (Melaleuca quinquenervia); Palm, Queen (Cocos plumose); Pecan Tree (Carya pecan (illinoensis); Pepper Tree, California (Schinus molle); Pine Mix (Lodgepole & Western Yellow Pine); Privet, Common (Lingustrum vulgare); Russian Olive (Elaeagnus angustifolia); Sycamore, American (Platanus occidentalis); Tree Mix (Pecan, Maple, Oak, American Sycamore, Black Willow); Tree Mix (White Ash, American Beech, Birch, Black Walnut, Common Cottonwood, American Elm); Tree Mix (White Ash, American Beech, River/Red Birch, Black Walnut, Common Cottonwood, American Elm, Shagbark Hickory, Hard Maple, Red Oak, American Sycamore, Black Willow); Walnut, Black (Juglans nigra); Willow, Black (Salix nigra); and the like.

There are a number of different allergens configured in the grass sub-vector group. In one embodiment, the allergens in this grass sub-vector group include one or more of Acacia, Bahia Grass (Paspalum notatum); Bermuda Grass (Cynodon dactylon); Bluegrass, Kentucky (Poa pratensis); Brome, Smooth (Bromus inermis); Corn, Cultivated (Zea mays); Fescue, Meadow (Festuca elatior (pratensis); Grass Mix (Kentucky Bluegrass, Orchard, Redtop, Timothy); Grass Mix (Kentucky Bluegrass, Orchard, Redtop, Timothy, Sweet Vernalgrass); Grass Mix (Kentucky Bluegrass, Orchard, Redtop, Timothy, Sweet Vernalgrass, Meadow Fescue, Perennial Ryegrass); Grass Mix (Kentucky Bluegrass, Bermuda, Johnson, Redtop, Timothy); Johnson Grass (Sorghum halepense); Oats, Common Cultivated (Avena sativa); Orchard Grass (Dactylis glomerate); Redtop (Agrostis gigantea (alba)); Ryegrass, Perennial (Lolium perenne); Southern Grass Mix (Kentucky Bluegrass, Orchard, Redtop, Timothy, Sweet Vernalgrass, Bermuda, Johnson); Sweet Vernalgrass (Anthoxanthum odoratum); Timothy (Phleum pratense); and the like.

There are a number of different allergens configured in the weed sub-vector group. In one embodiment, the allergens the weed sub-vector group include one or more of Acacia, Careless Weed (Amaranthus palmeri); Careless/Pigweed (Careless Weed & Rough Redroot Pigweed); Cocklebur, Common (Xanthium strumarium); Dock/Sorrel Mix (Yellow Dock & Sheep Sorrel); Goldenrod (Solidago canadensis); Kochia (Kochia scoparia); Lamb's Quarters (Chenopodium album); Marshelder/Poverty Mix (Burwee, Povertyweed & True Marshelder); Nettle (Urtica dioica); Dog Fennel, Eastern (Eupatorium capillifolium); Pigweed, Rough Redroot (Amaranthus retroflexus); Plantain, English (Plantago lanceolata); Ragweed, Giant (Ambrosia trifida); Ragweed, Short (Ambrosia artemisilifolia); Ragweed, Western (Ambrosia psilostachya); Ragweed Mix (Giant & Short Ragweed); Ragweed (Giant, Short & Western Ragweed); Russian Thistle (Salsola kali); Sagebrush, Mugwort (Artemisia vulgaris Heterophylla (douglasiana)); Scale, Wing (Atriplex canescens); Sheep Sorrel (Rumex acetosella); Weed Mix 2630 (Common Cocklebur, Lamb's Quarters, Rough Redroot Pigweed, Dock/Sorrel); and the like.

There are a number of different allergens configured in the mold sub-vector group. In one embodiment, the allergens the mold sub-vector group include one or more of Alternaria-Hormodendrum Mix (Alternaria tenuis, Hormodendrum cladosporioides); Alternaria tenuis; Aspergillus fumigatus; Aspergillus niger; Botrytis cinerea; Candida albicans; Cephalosporium acremonium; Curvularia spicifera; Epicoccum nigrum; Epidermophyton floccosum; Fusarium vasinfectum; Helminthosporium interseminatum; Hormodendrum cladosporioides; Mucor racemosus; Penicillium Mix (p. digitatum, expansum, glaucum, roseum, notatum); Penicillium notatum; Phoma herbarum; Pullularia pullulans; Rhizopus nigricans; Stemphylium botryosum; Trichopyton Mix (T. tonsurans, rubrum, mentagrophytes); Mold Mix (Alternaria tenuis, Aspergillus Mix (A. fumigatus, nidulans, niger, terreus), Hormodendrum cladosporioides, Penicillium Mix (P. digitatum, expansum, glaucum, notatum, roseum); Mold Mix Alternaria tenuis, Aspergillus Mix (A. fumigatus, nidulans, niger, terreus), Fusarium vasinfectum, Helminthosporium interseminatum, Hormodendrum cladosporioides, Mucor racemosus, Penicillium Mix (P. digitatum, expansum, glaucum, notatum, roseum), Phoma herbarum, Pullularia pullulans, Rhizopus nigricans; and the like.

There are a number of different allergens configured in the animal vector group. In one embodiment, the allergens in this animal vector includes one or more of Dog Hair and Dander (Mixed breeds); Feather Mix (Chicken, Duck and Goose); Guinea Pig Hair and Dander; Cat Pelt; Cat Hair; Cattle Hair and Dander; Horse Hair and Dander; House Dust Mix (Feather and Mattress dust), DP Mite and DF Mite (even though not an animal); and the like.

There are a number of different allergens configured in the environmental sub-vector group. In one embodiment, the allergens in this mold sub-vector group includes one or more of Alternaria tenuis; Aspergillus fumigatus; Aspergillus niger; Candida albicans; Cephalosporium acremonium; Curvularia spicifera; Epidermophyton floccosum; Fusarium vasinfectum; Mucor racemosus; Hormodendrum; Helminthosporum; Penicillium Mix; Phoma herbarum; Pullularia pullulans; Rhizopus nigricans; Stemphylium botryosum; Trichopylton Mix; Epicoccum nigrum; Botrytis cinerea, cockroach mix (even though not a mold), and the like.

In one embodiment, a method for generating a patient specific immunotherapy treatment recommendation at one or more devices that includes receiving, from one or more locations, a first input comprising information indicative of a patient medical history, a second input comprising information having characteristics indicative of one or more science factors, a third input comprising information having characteristics indicative of a patient's immune response to one or more antigens of a test; and generating, using a processor, an immunotherapy treatment recommendation based on the first input, the second input and the third input.

In one embodiment, a system for generating a patient specific immunotherapy treatment recommendation that includes a network interface configured to receive a first input, second input and third input. A first input includes information having characteristics indicative of a patient's medical history, a second input includes information having characteristics indicative of one or more science factors, and a third input includes information having characteristics indicative of a patient's immune response to one or more antigens of a test. The system, e.g., a processor on one or more of a server, patient device or provider device are configured to process the first input, the second input and the third input to determine an immunotherapy treatment recommendation.

In one embodiment, a computer device includes at least one processor and at least one memory. The at least one processor and the at least one memory are communicatively arranged to generate an immunotherapy treatment recommendation from one or more inputs received from a provider device comprising at least one processor and at least one memory, provide the immunotherapy treatment recommendation to the provider device, and receive a verification of the immunotherapy treatment recommendation from the provider device.

In one embodiment, an immunotherapy system includes a provider device and a server. The provider device includes at least one processor and at least one memory and the server includes at least one processor and at least one memory configured to generate an immunotherapy treatment recommendation from one or more inputs received from the provider device over a network. The server is configured to provide the immunotherapy treatment recommendation to the provider device over the network and the server is configured to receive a verification of the immunotherapy treatment recommendation from the provider device over the network.

In one embodiment, a computer-readable storage medium tangibly embodying a program of instructions executable by a machine includes a plurality of program code to implement processes described herein. In a preferred embodiment, the program code includes program instruction including a plurality of program codes for managing immunotherapy. The program instructions include program code for generating an immunotherapy treatment recommendation with a server, program code for providing the immunotherapy treatment recommendation to a provider device and program code for receiving a verification of the immunotherapy treatment recommendation from the provider device.

In one embodiment, a cloud based storage medium tangibly embodies a program of instructions executable by a machine wherein said program of instruction comprises a plurality of program codes for managing immunotherapy. The program instructions include program code for generating an immunotherapy treatment recommendation with a server, program code for providing the immunotherapy treatment recommendation to a provider device, and program code for receiving a verification of the immunotherapy treatment recommendation from the provider device.

In one embodiment, a method for providing immunotherapy treatment recommendations to a medical provider includes generating an immunotherapy treatment recommendation with a provider device. The method also includes providing the immunotherapy treatment recommendation to the provider device and receiving a verification of the immunotherapy treatment recommendation from the provider device.

Reference will now be made in detail to embodiments of the invention, examples of which are illustrated in the accompanying drawings.

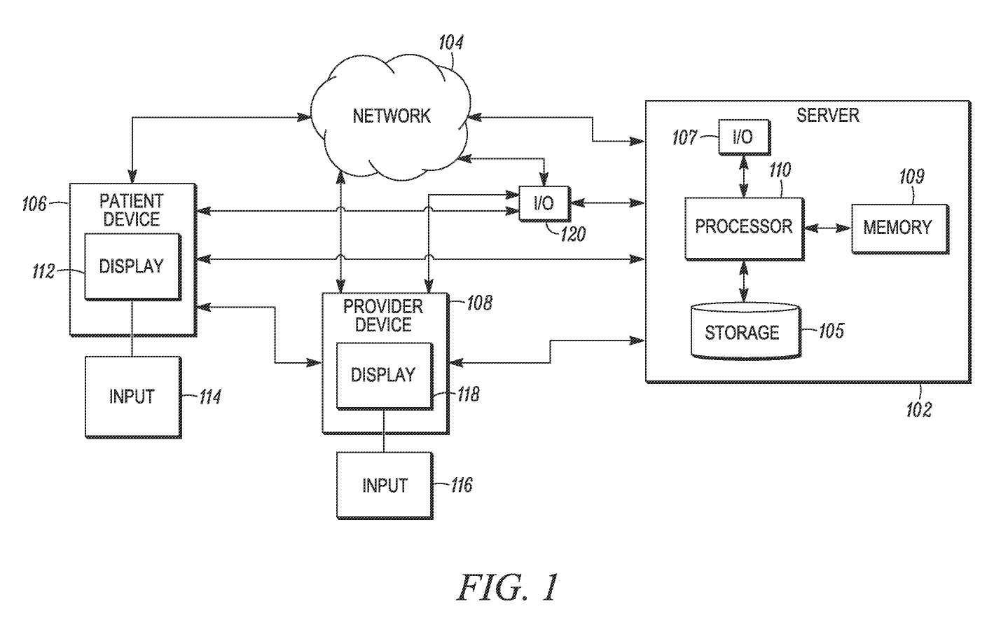

FIG. 1 illustrates an exemplary block diagram depicting an online immunotherapy system according to an embodiment of the invention;

Referring to FIG. 1, an immunotherapy system is generally depicted with reference to number 100 and is configured to create, share, monitor and distribute treatments for immunotherapy to the patient, provider and insurance carrier (not shown) and/or other third parties. The system 100 is configured to communicate with a patient, provider and/or a partner, e.g., an insurance carrier, directly and/or over a communications network. The patient is the one receiving the treatment. The provider may be a health care provider, physician or caregiver at an office, home or some other location.

In this embodiment, the system 100 includes a server 102 in communication over a network 104 with one or more patient devices 106 and one or more provider device 108 via one or more network interfaces or other technique as known in the art. Optionally, one or more I/O 120 is also in communication over the network 104. In one embodiment, the server 102 includes a processor 110, a memory 109, I/O 107, and storage 105 in communication with each other. The patient device 106 and provider device 108 also each include a processor, a memory, I/O, and storage in communication with each other.

The server 102, patient device 106, and provider device 108 are each configured to send, receive, process, evaluate, program, and otherwise process modules according to the invention either singly or in combination. The server 102 may be configured to locate, e.g., wirelessly locate, the position of one or more patients 106 and/or providers 108 with techniques are known in the art, e.g., triangulation, GPS, Wi-Fi estimation or other estimation techniques as known in the art. In addition, the system 100 is configured to process the modules or functional units as described herein and communicate and output data or screen shots and other graphics in connection therewith.

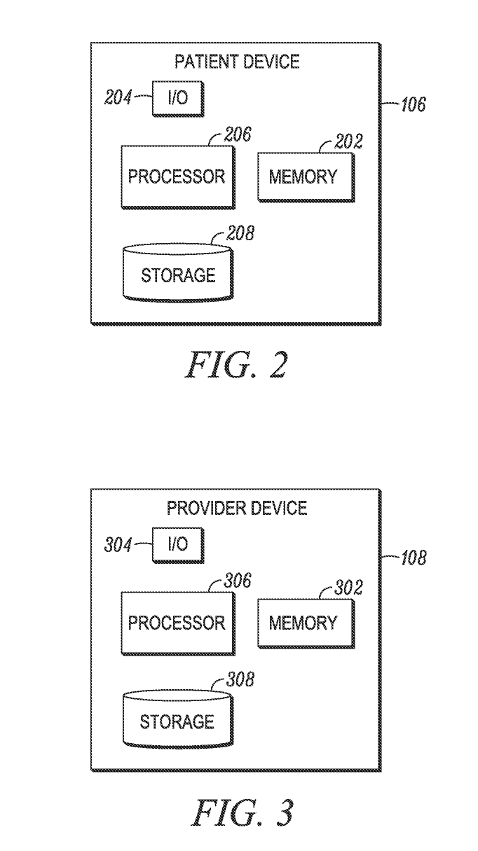

FIG. 2 illustrates an exemplary block diagram of a patient device according to an embodiment of the invention. FIG. 3 illustrates an exemplary block diagram of a provider device according to an embodiment of the invention.

Referring to FIGS. 2 and 3, the patient device 106 includes a processor 206, a memory 202, I/O 204, and storage 208 in communication with each other. The provider device 108 includes a processor 306, a memory 302, I/O 304, and storage 308 in communication with each other.

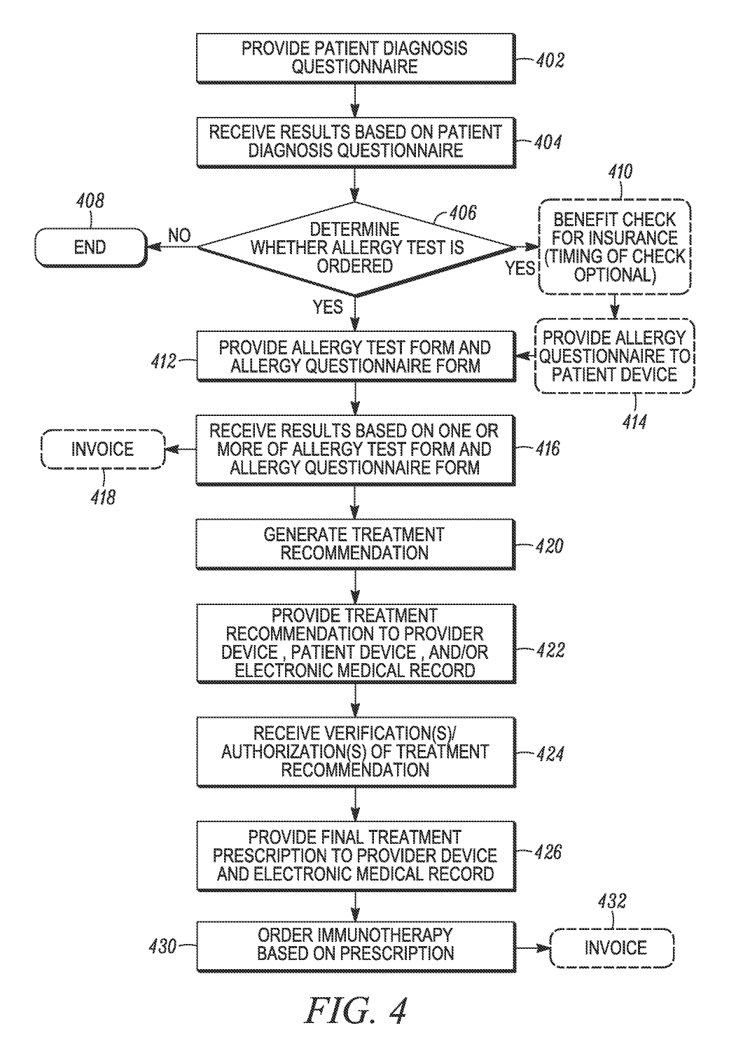

FIG. 4 illustrates an exemplary block diagram of an immunotherapy process conducted with the system according to an embodiment of the invention.

Referring to FIG. 4, a process conducted with the system 100 is generally depicted with reference to number 400. In this embodiment, the process 400 includes step 402; in step 402, a patient diagnosis questionnaire is provided to one or more of a patient device 106, a provider device 108, I/O 112 and/or an electronic medical record (EMR) system via a network. For example, the patient diagnosis questionnaire is transmitted over the network to the device, the patient diagnosis questionnaire is sent from a storage or memory on the device in response to a processor request, or a combination of the same.

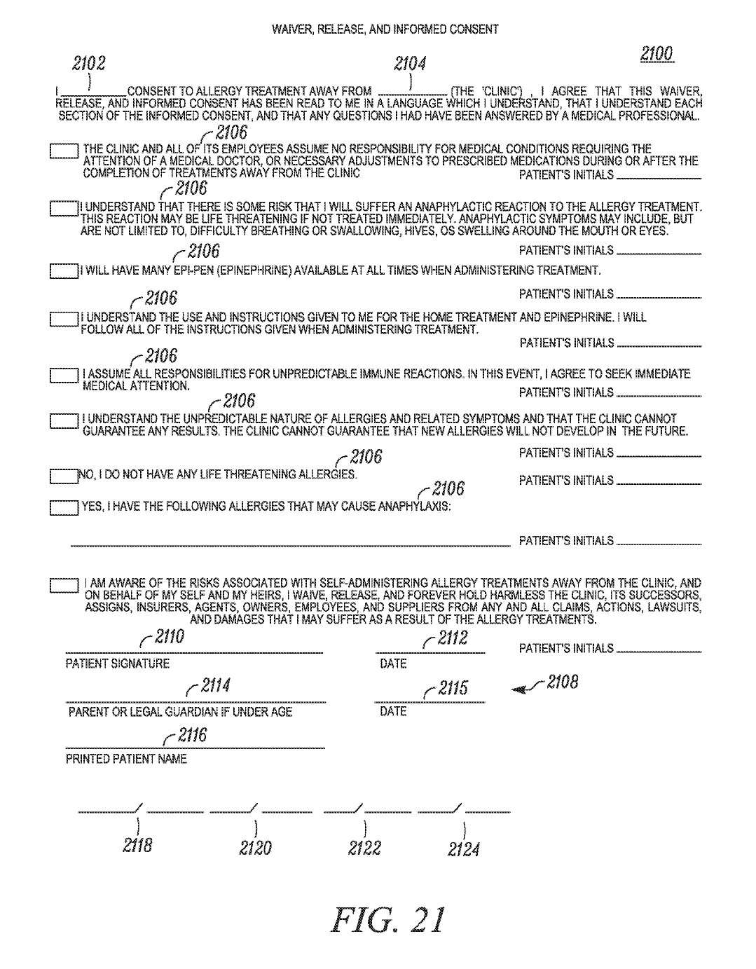

In one embodiment, the system 100 is configured to communicate a patient diagnosis questionnaire to a provider device 108, a patient device 106, an I/O 112, an electronic medical record (EMR) system or a combination of the same or another device. The patient diagnosis questionnaire may be presented as a software application on the provider device 108, as list or in other different forms, where a user can select and/or provide answers to individual elements of the patient diagnosis questionnaire. In one embodiment, the patient diagnosis questionnaire may be provided with or integrated into an electronic medical record (EMR) system and/or billing system. A user may respond to the questions on the patient diagnosis questionnaire directly or indirectly via one or more of a provider device 108, patient device 106, and/or I/O 112 directly. In one embodiment, the patient diagnosis questionnaire includes a series of questions configured to achieve a diagnosis of a patient condition. In one embodiment, the diagnostic questionnaire is customizable by the provider or third party. By way of example, a sample patient diagnosis questionnaire screen shot is shown in FIG. 21.

In step 404, results of the patient diagnosis questionnaire form are received from a provider device 108 or a patient device 106 at the server 102 and are stored in a database of the server, e.g., in storage 105 and/or memory 106. Optionally, the database may be stored off the server 102 on an internet based storage device, e.g., cloud based. Optionally and/or alternatively, the results are received at a processor of any device described herein, e.g., when an application is being utilized to administer the patient diagnosis questionnaire form.

In step 406, the server 102, e.g., processor 110, is configured to determine whether an allergy test is ordered by retrieving information or data based on the patient diagnosis questionnaire form and comparing it against a predetermined criteria. In one embodiment, the predetermined criteria includes whether the provider has provided a diagnosis or code that authorizes such an allergy test. If it is programmatically deduced that an allergy test is not ordered no further action is taken (step 408). If it is programmatically deduced that an allergy test is to be ordered the process moves to step 412 and optionally step 410. In step 410, a benefit check module or database is consulted to determine whether a patient has sufficient insurance coverage for at least the immunotherapy treatments described herein, e.g., specific patient allergy test, immunotherapy treatment set and continued treatment of immunotherapy. This step may be performed before or after any of the steps described herein. Optionally, a location of the provider and identification of the same may be automatically obtained, e.g., GPS location, Wi-Fi location or other technique as known in the art. The location may be compared to know providers to confirm provider identification and location of the clinic.

In one embodiment, in step 410, the server retrieves insurance information about the patient from one or more devices or other inputs in the server and communicates directly with a third party, e.g., an insurance carrier, in order to obtain indication of whether the allergy test is covered by the patient's insurance company. When it is determined affirmatively that a patient has insurance coverage for allergy testing then step 412 is performed (step 414). If no insurance or non-coverage is determined (step 410) then an alert is sent to the system 100 to the provider of the same; the alert may be sent with phone, EMR, email, SMS, combination of the same, or other communication technique as described herein.

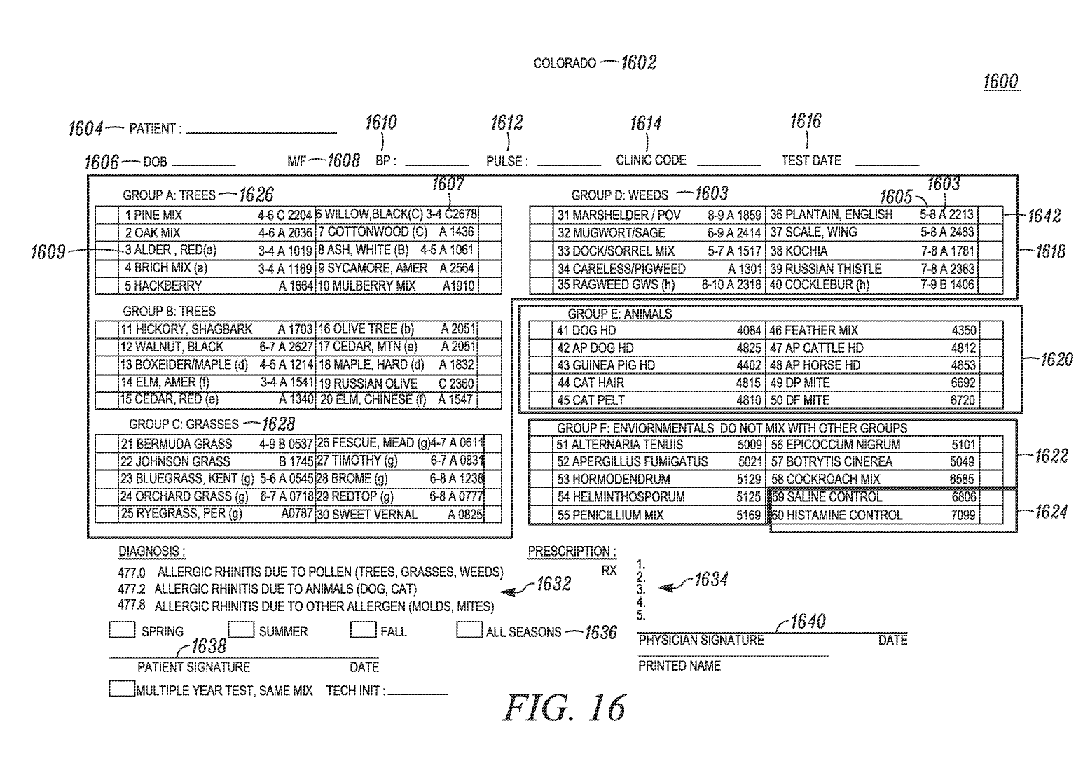

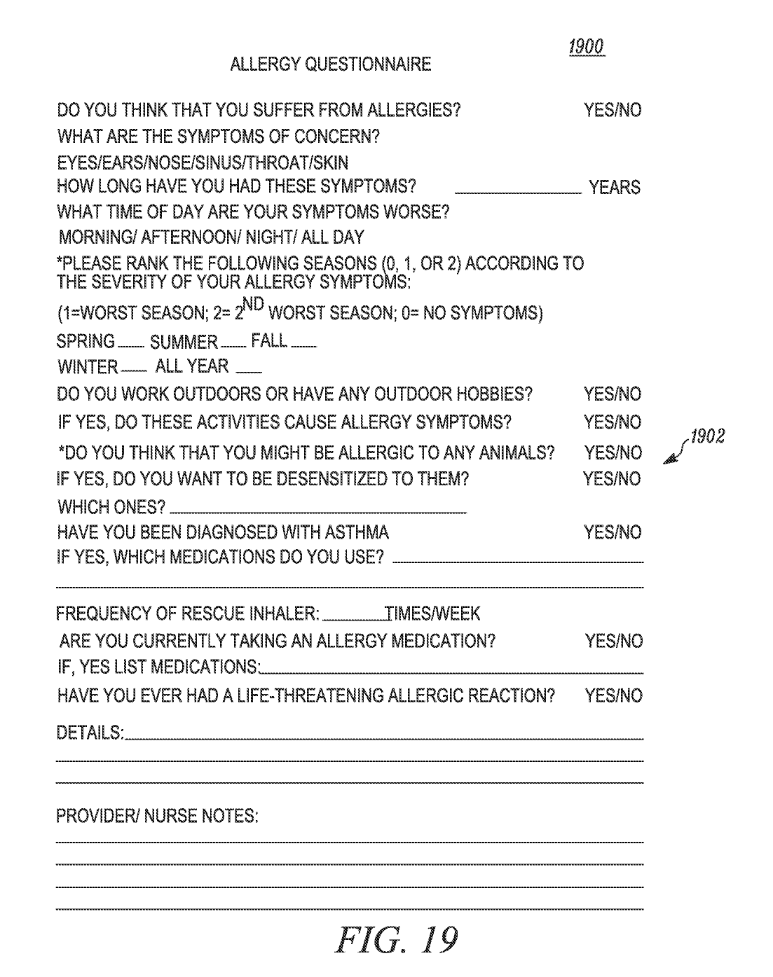

In step 412, a server 102 is configured to communicate an allergy test form and allergy questionnaire form to a provider device 108, patient device 106, an electronic medical record system, or other device. The allergy questionnaire form may be provided earlier in the process or concurrently with any previous steps. In this embodiment, the allergy test form and allergy questionnaire form are presented as a software application on one or more of the provider device 108, patient device 106, or a combination of devices, as a list or in other different forms, where a user can select and/or provide responses. For example, the allergy test form is sent to the provider device 108 or third party and the allergy questionnaire form is provided to the patient device 106. By way of example, an allergy test form screen shot is in FIG. 16 and the allergy questionnaire form screen shot is shown in FIG. 19.

Both forms are customizable by the provider or other third party. In one embodiment, the allergy questionnaire form may include patient history questions and is provided in part or in full to both the patient device 106 and the provider device 108 or portal 120 at any time, e.g., before, during or after a meeting with the provider. The allergy test form may include information to receive from an in vivo immunotherapy test or an in vitro immunotherapy test or both. The results are obtained either manually, electronically or both and may be provided into the allergy test form (step 416).

In step 416, the results of a completed allergy test form and allergy questionnaire form are provided with a component or device of the system 100. That is, a user may respond via one or more of a provider device 108, patient device 106, and/or I/O 112 directly to the questions on the forms. The received information may be at any of the devices or server. The results of the allergy test form include information indicative of a patient's immune response to one or more allergens of a test, e.g., a numerical value based on one or more of an actual size of a wheal diameter, a radioimmunoassay blood test, an enzyme-linked immunosorbent assay, an IgE blood test, and/or blood test. In a preferred embodiment, the results of an allergy test are input into a provider device and are based on results of an in vivo test, i.e., numerical values based on one or more of an actual size of a wheal diameter as a response to one or more allergens as known in the art.

Optionally and/or alternatively, both forms are dynamic forms that may be adjusted in real time. For example, the allergy test form received in step 412 is adjusted by a provider either manually or automatically by inputting the patient's results into the form. In one embodiment, the results are determined by measuring the size of the wheal associated with each allergen. In a preferred embodiment, the measurement is done with an allergy skin test ruler as known in the art. These values are input in the provider device to populate the form and received by the system in step 416. Alternatively and/or optionally, the results are obtained automatically, e.g., by taking an image of the patient's treated area and programically deducing the numerical values.

Optionally, in step 418, the system 100 is configured to generate one or more invoices. The invoices can also be sent to one or more of an insurance company, provider and patient via communication. The invoice may include charges associated with the allergy test, service charges, test kit charges and/or other customary charges of a provider.

In step 420, a treatment recommendation is generated on one or more of a network 104, a server 102, a provider device 108 or a patient device 106. The treatment recommendation is a programmatically deduced immunotherapy treatment recommendation based on one or more of a patient's history information, science factors, and a patient's results to the allergy test. In a preferred embodiment, the treatment recommendation is generated or integrated in the existing allergy test form. The treatment recommendation includes a selection of one or more allergens to treat the patient. In a preferred embodiment, the treatment recommendation includes five allergens to treat the patient with.

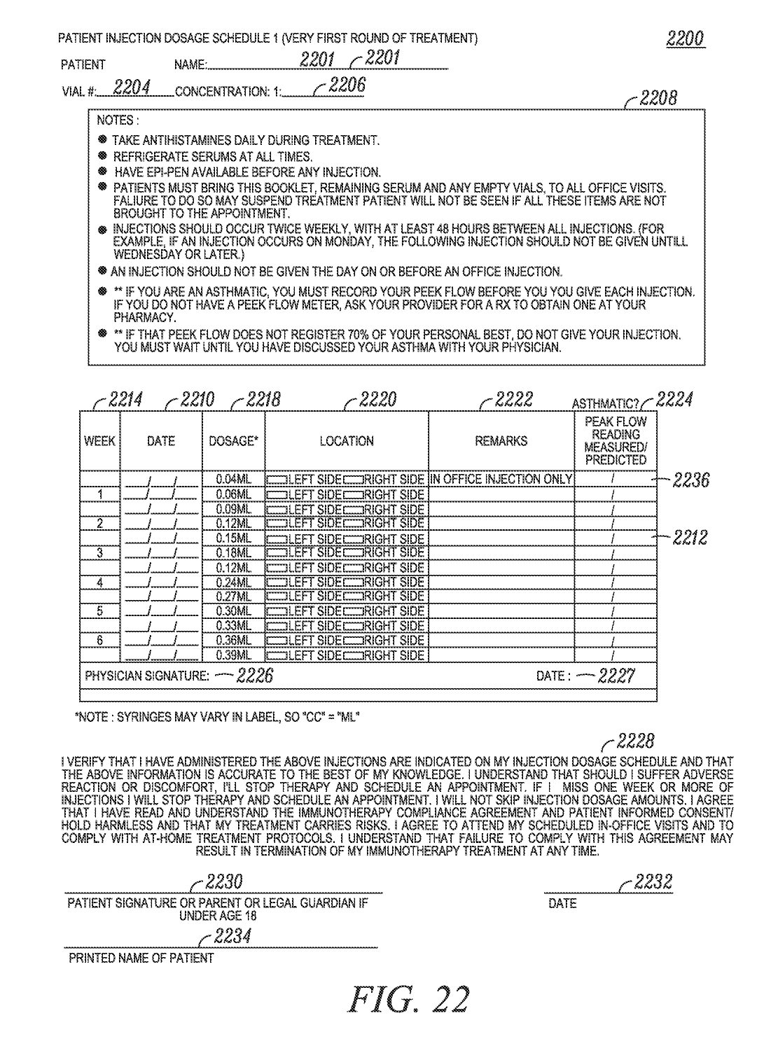

Optionally and/or alternatively, a treatment recommendation 420 also includes one or more schedules for treating a patient with one or more allergens correlated with a schedule of treatments and concentrations. By way of example, this embodiment is directed towards a treatment of one year or more administered as schedule 1, schedule 2, schedule 3, schedule 4 and schedule 5 (maintenance 1 & 2). These schedules are provided from the server 102 to a patient device 106, provider device 108, EMR system, or any combination. An example of a screen shot of schedule and more details about the schedule are described herein with reference to FIG. 22.

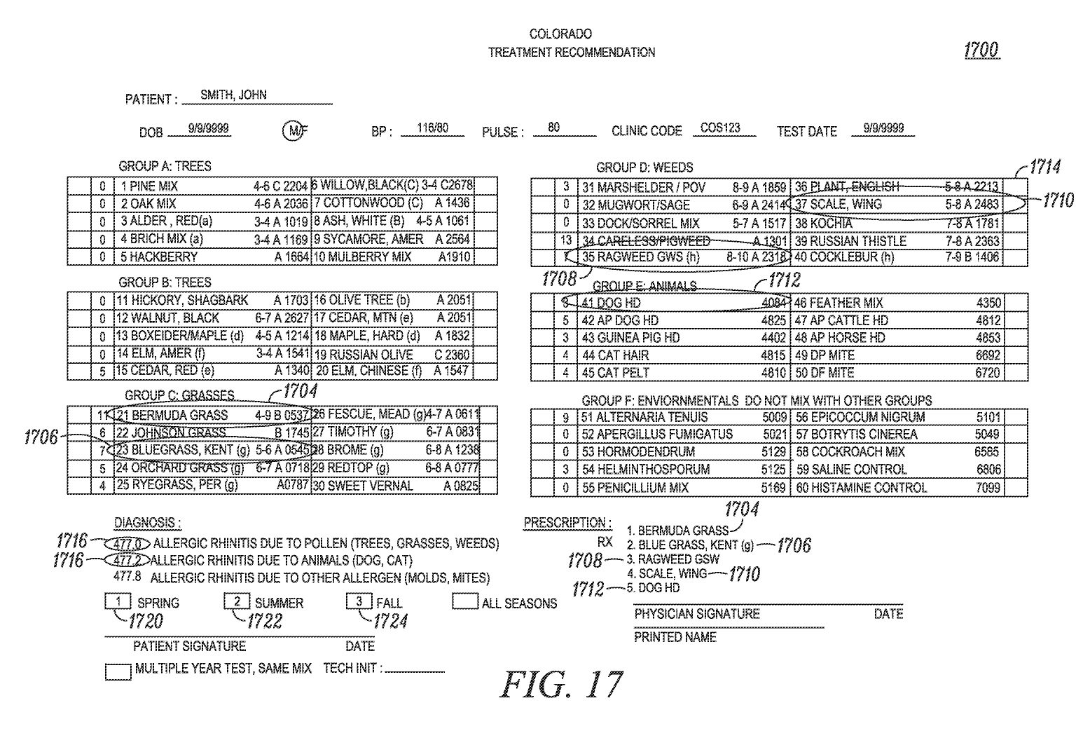

In this embodiment, in step 422 a server 102 is configured to provide the treatment recommendation to one or more of a provider device 108, a patient device 106, an EMR system, and combination of the same. Optionally and/or alternatively, the treatment recommendation is provided by a processor on one or more of the provider device 108, the patient device 106, the EMR system, and the network 104. A screen shot of a treatment recommendation is shown in FIG. 17. The treatment recommendation includes at least one or more allergens to treat a patient; these are emphasized, e.g., circled. The allergens are listed in a separate or integrated prescription and authorization portion for a patient and/or provider to approve.

In step 424, the treatment recommendation is received on or more devices or server of the system. The system 100 is configured to receive and store an authorized verification of treatment recommendation. In addition, the system is configured to receive electronic signatures and/or adjustments to the treatment recommendation. Adjustments can include changes to the treatment recommendation from the provider. The changes may include adding allergens, subtracting allergens, reordering allergens by adjusting the ranking of the allergens or other changes.

By way of example, the treatment recommendation is converted into a prescription by the provider's authorization. An example screen shot of a final treatment recommendation, including a prescription, is shown in FIG. 17. In step 426, the final treatment prescription is provided to one or more of the provider device 108, patient device 106, EMR system, or other device. In step 430, the system 100 is configured to order the allergen treatment set in accordance with the prescription. This may be ordered by the provider or third-party with the system.

Optionally, in step 432, the system 100 is configured to generate one or more invoices. The invoices are sent to one or more of an insurance company, provider, patient and/or third party. The invoice includes charges associated with generating the immunotherapy treatment, e.g., service charges for generating the treatment, prescription charges and optionally other charges.

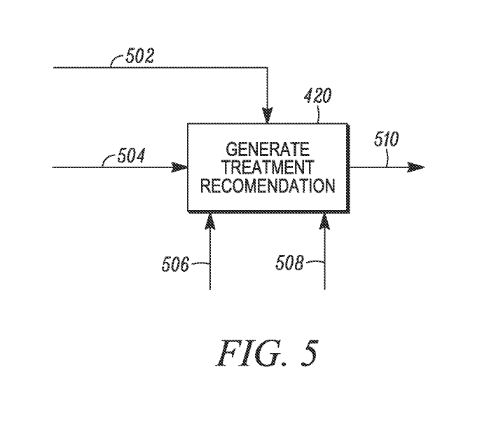

FIG. 5 illustrates an exemplary block diagram of generating an immunotherapy treatment recommendation conducted with the system according to an embodiment of the invention.

Referring to FIG. 5, the step 420 of generating a treatment recommendation is described with reference to module 420. In this embodiment, the treatment recommendation is based on a first input, a second input and a third input and is programically deduced based on information in those inputs. Specifically, an application and/or software residing on a patient device 106, provider device 108, server 102, network 104 or combination thereof is configured to receive a first input 502 including information indicative of a patient's medical history, a second input 504 including information having characteristics indicative of one or more science factors, and a third input 506 including information having characteristics indicative of a patient's immune response to one or more antigens of a test and configure to generate, e.g., using a processor, an immunotherapy treatment recommendation based on the first input 502, the second input 504 and the third input 506. The system generates a treatment recommendation as an output 510 based on the first input, the second input and the third input. In a preferred embodiment, the generation is described with regards to step 422. Optionally, and/or alternatively, a fourth input 508 may also be used and includes other information that can be used in generating the treatment recommendation, e.g., EMR input, insurance information, and the like.

In one embodiment, the first input 502 includes information indicative of a patient's medical history, such as, one or more of information having characteristics indicative of one or more patient symptoms correlated with one or more of a time of the symptom, a location of the symptom, characteristics of location of the symptom, a duration of symptom, a ranking of seasonal according to severity of symptoms, highest of symptoms occurrence relative to indoor environment or outdoor environment, patient treatment preferences, patient medical history including one or more of patient's name, date of birth, date of service, name of clinic location, clinic code, blood pressure, peak flow of lung volume, pulse, pulse oxygen content, preexisting conditions, current medications, past medications, patient insurance information, electronic medical records, and pregnant status and desire to become pregnant, combinations of the same of the same and the like.

The second input 504 includes information having characteristics indicative of one or more science factors, such as, one or more information indicative of one or more of a protein component of one or more animal, plant, tree, weed, grass, mold, and insect, associated with each a specific vector group, sub-vector group or both; a size of pollen of one or more plant, tree, weed, or grass associated with each a specific vector group, sub-vector group or both, an amount of pollen produced per predetermined time of one or more plant, tree, weed, or grass associated with each a specific vector group, sub-vector group or both; a cross-reactivity designation of one or more antigens in each sub-vector group; a frequency designation of one or more plant, tree, weed, or grass associated with each a specific vector group, sub-vector group or both in a predetermined area, e.g., bounded area, such as a city, neighborhood or the like; meteorological factors associated with one or more plant, tree, weed, or grass associated with each a specific vector group, sub-vector group, e.g., these factors are indicative of pollen being produced and dispersion of the same and may also include temperature, pressure, wind, precipitation, that impact one or more of pollen productions, dispersion, combinations of the same and the like. Alternatively and/or optionally, the science factors may include a pollination weighting factor indicative of pollination characteristics and/or timing of each allergen in the pollen vector group.

The third input 506 includes information having characteristics indicative of a patient's immune response to one or more antigens of a test and configure to generate, such as, information having characteristics indicative a patient's immune response to one or more antigens of a test comprises a numerical value based on one or more of an actual size of a wheal diameter, radioimmunoassay blood test, enzyme-linked immunosorbent assay, IgE blood test, blood test, combinations of the same and the like. The response may be any numerical value representative of an immune response to an in vivo allergy test and/or an in vitro allergy test.

FIG. 6 illustrates an exemplary block diagram of generating an immunotherapy treatment recommendation conducted with the system according to an embodiment of the invention.

Referring to FIG. 6, in step 602 results are received on the system 100, e.g., in memory or storage, based on one or more of an allergy test form, an allergy questionnaire form and optionally other inputs or sources. In this embodiment, the steps of FIG. 6 may be conducted by an application or software on a server 102, a patient device 106, a provider device 108, an electronic medical record system, or any combination of each. In a preferred embodiment, a processor on the provider device 108 is configured to generate the treatment recommendation.

In step 604 an allergen treatment data set is generated and stored in a database on the system 100. The allergen treatment data set is a finite set of allergens corresponding to allergens tested on a patient in the allergy test. In step 606, each of the allergens from the allergen treatment data set is grouped into one or more categories, e.g., specific vector groups and/or sub-vector groups. This grouping is done by comparing the allergens of the treatment dataset to the properties of each allergen in a database on the system, e.g., in memory and/or storage. This grouping database may be adjusted with other factors as described herein.

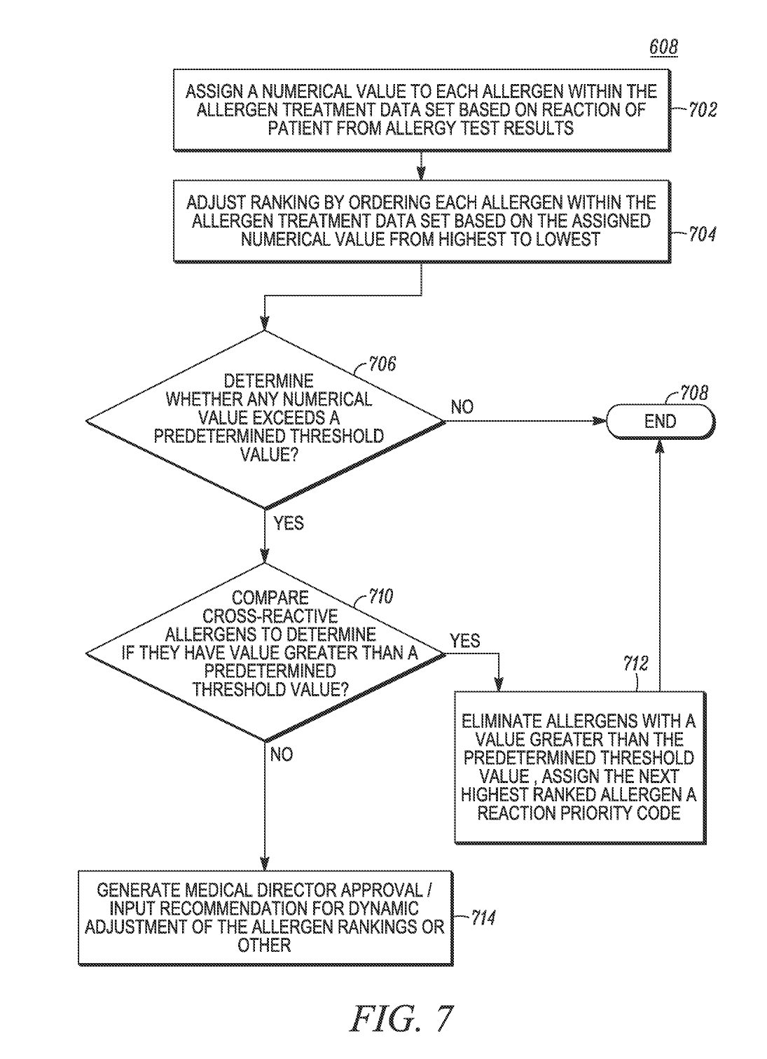

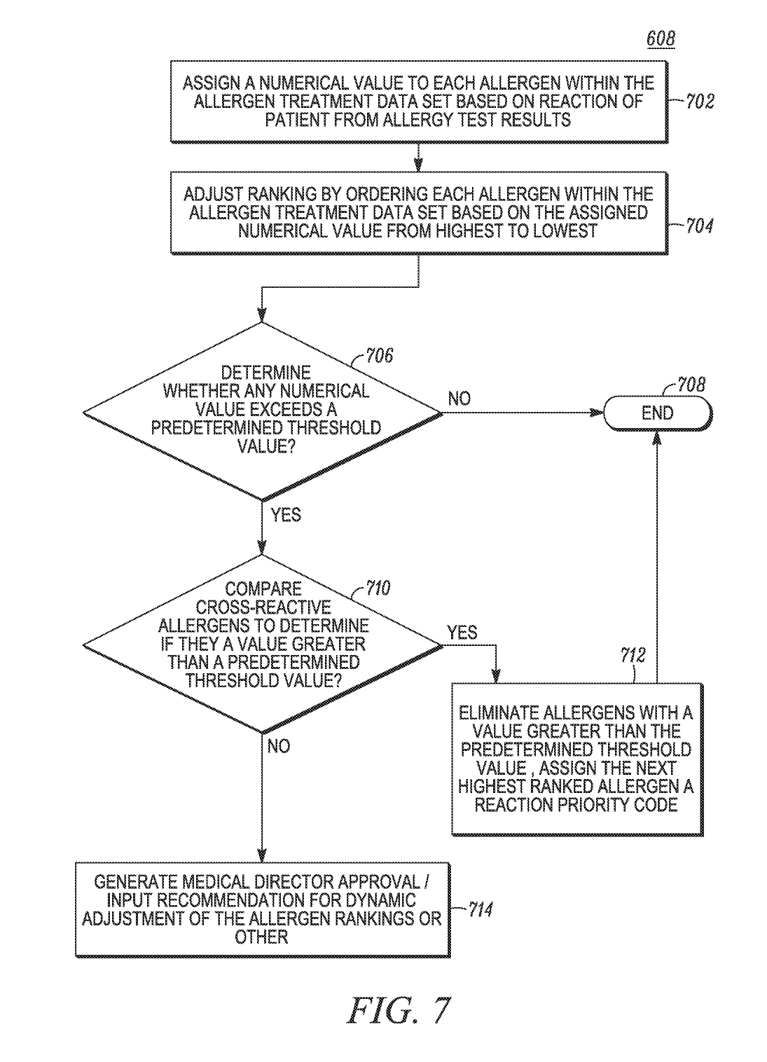

In step 608, allergens are ranked in a numerical fashion or other fashion based on the received and/or stored numerical results from the allergy test. By way of example, if numerical value from the allergy test indicates that an allergen elicited an immune response, e.g., 7 mm size wheal, the numerical value of that allergen is 7. In a preferred embodiment, the ranking is from highest to lowest. FIG. 7 illustrates an exemplary block diagram of ranking allergens of an allergen treatment data set with the system according to an embodiment of the invention.

Referring to FIG. 7, the ranking step 608 is described with regards to a preferred embodiment in FIG. 7. In step 702, the system 100 is configured to assign a numerical value to each allergen within the allergen treatment data set based on the reaction of the patient from allergy test results, e.g., whole numbers corresponding to the actual size of wheal diameter in [mm] in a range from about 1 mm to about 30 mm or greater. These are stored on the system in memory or storage on a device, server, network or combination. In step 704, the system 100 is configured to adjust the ranking by ordering each allergen from highest lowest based on the assigned ranking. In step 706, the system 100, e.g., processor, is configured to determine whether any numerical value of any of the allergens exceeds a predetermined number by comparing the numerical value of the allergen to a predetermined threshold value. The predetermined threshold value is selected based on unacceptable reaction to the allergy test, e.g., previous experiences or other factors known in the art. The unacceptable reaction indicates that a patient may enter into anaphylaxis should the allergen be administered in an immunotherapy treatment as known in the art. Anaphylaxis is a serious allergic reaction that is rapid in onset and may cause death if treated with the allergen. This predetermined number is dependent on the allergy test administered. In a preferred embodiment, when an in vivo allergy test is administered, the predetermined threshold is 20 or greater and this value is chosen to ensure minimal or no adverse reactions. The 20 corresponds to a 20 mm wheal size reaction to an allergen of the test.

If the numerical value does not exceed a predetermined threshold value then process goes to step 708. In step 708, the assigning step 608 ends and step 610 can be conducted. If the numerical value exceeds a predetermined threshold value then the process goes to step 710. In step 710, the system 100 determines whether there are allergens within a sub-vector group having the same cross-reactivity that have a numerical value greater than a predetermined threshold. The predetermined threshold is described with reference to step 706. In a preferred embodiment, the predetermined threshold is 20 or more. If satisfied then the process goes to step 712 where the allergen having a value greater than a predetermined threshold is eliminated and the next highest ranked cross-reactive allergen having a predetermined numerical range, e.g., between 10-20, is assigned a reaction priority code. Next, the process can end with step 708. If not satisfied, the process goes to step 714. In step 714, a dynamic communication is sent to the provider device 108 to permit the provider access to providing a dynamic adjustment to the treatment recommendation and/or consult with another provider.

In step 610, a cross-reactive priority code is assigned to allergens within each sub-vector group. The cross-reactive priority code is indicative of similar allergenicity, e.g., different grass species may have similar allergen proteins, thereby resulting in similar reactions even though they are different allergens. The cross-reactive priority code may include a numerical value, color, or other code indicative of cross-reactivity between allergens.

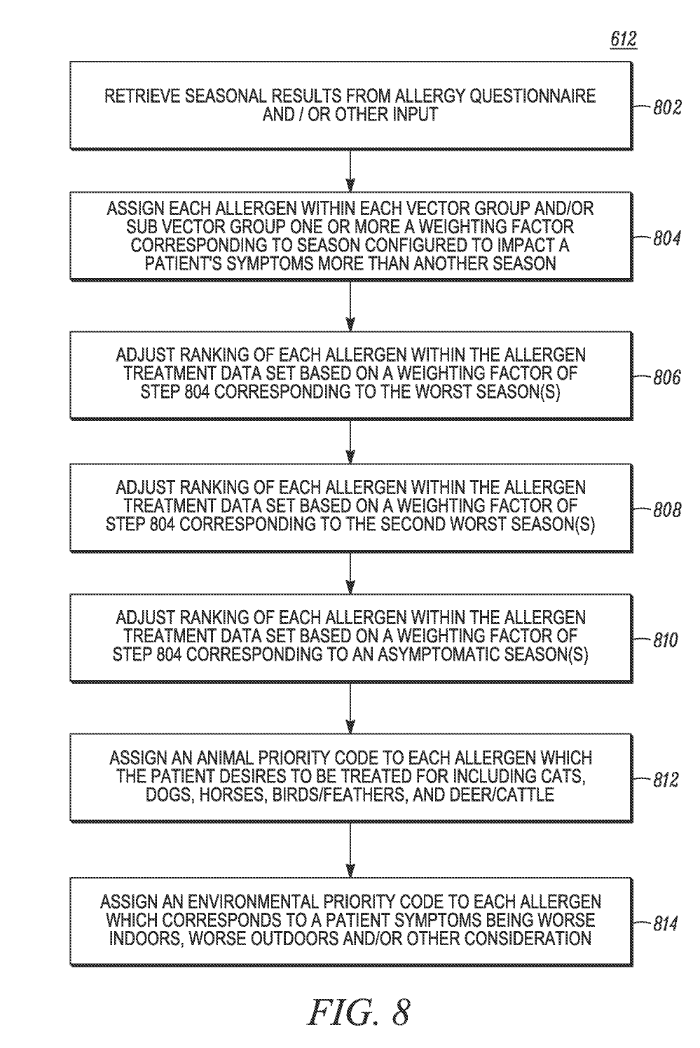

In step 612, the previous ranking of the allergens within the allergen treatment set are adjusted (reordered) based on the received allergy questionnaire information. FIG. 8 illustrates an exemplary block diagram of adjusting the ranking allergens of an allergen treatment data set conducted with the system based on an allergy questionnaire according to an embodiment of the invention. Referring to FIG. 8, the adjusting ranking step 612 is described with regard to a preferred embodiment in FIG. 8. The ranking is adjusted by the system 100 based on results of the allergy questionnaire. In step 802, Seasonal result information is received from the allergy questionnaire (FIG. 19). The seasonal result information is configured to indicate what season the patient has their worst symptoms and second worst symptoms. These results are stored in a database on the system 100. The results may also be combined with science factors indicating which season has the highest likelihood of causing symptoms, e.g., which season has the highest pollen count per allergen in the pollen vector group.

In step 804, the system 100 is configured to assign each allergen within the vector group one or more seasons in which the season has an impact on the allergen vector to a patient's symptoms. For example, a season in which science factors or other factors indicate that the season has a higher likelihood of causing symptoms to a patient. In this embodiment, the assignment includes one of spring, summer, fall, winter and/or year round. In addition, the seasons may be further incremented by a month range or day range. In a preferred embodiment, these assignments are stored in a database of the system 100. The assignment may also be graphically denoted on a final treatment recommendation. In a preferred embodiment, the assignment also includes assigning a worst season indication to each allergen within the vector or sub-vector groups, second worst season indication to each allergen within the vector or sub-vector groups, and third worst season, fourth worst season and so on.

In step 806, the seasonal indications or factors of allergens in the database from step 804 are utilized to further adjust the ranking of each allergen. The adjustment is done by taking the previous adjustment, if any, and adding or subtracting a weighting factor based on the worst season weighting factor of step 804. This new ranking is stored as the new allergen treatment data set on the system 100 as was done with early embodiments. In a preferred embodiment, the worst season weighting factor raises the value of the associated allergen by two or more.

In step 808, the seasonal indications or factors of allergens in the database from step 806 are utilized to further adjust the ranking of each allergen. The adjustment is done by taking the previous adjustment, if any, and adding or subtracting a weighting factor based on the second worst season weighting factor of step 804. In a preferred embodiment, the second worst season weighting factor raises the value of the associated allergen by one or more. This new ranking is stored as the new allergen treatment data set on the system 100 as was done with early embodiments.

In step 810, the seasonal indications or factors of allergens in the database from step 808 are utilized to further adjust the ranking of each allergen. The adjustment is done by taking the previous adjustment, if any, and adding or subtracting a weighting factor based on an asymptomatic season weighting factor of step 804. In a preferred embodiment, the adjustment factor decreases the value. This new ranking is stored as the new allergen treatment data set on the system 100 as was done with early embodiments.

In step 812, the allergens in the database corresponding to animals are assigned an animal priority when it is determined from the allergy questionnaire that a patient desires to be treated for symptoms corresponding to a specific animal. The system 100 further stores these correlated animal priority codes in a database. These corresponding allergens to animals are input from a third party onto the system or previously designated by a provider's science factors.

In step 814, the allergens in the database corresponding to indoor symptoms are assigned an environmental priority code when it is determined from the allergy questionnaire that a patient has worse symptoms indoors and/or outdoors. In one embodiment, allergens associated with indoor symptoms and/or outdoor symptoms are compared to symptoms from the allergy questionnaire to determine whether or not to assign the environmental priority code. When it determined that there is a match a code is assigned. The code may include a separate indication for indoor and/or outdoor. These environmental coded allergens are stored on the system 100 in a database.

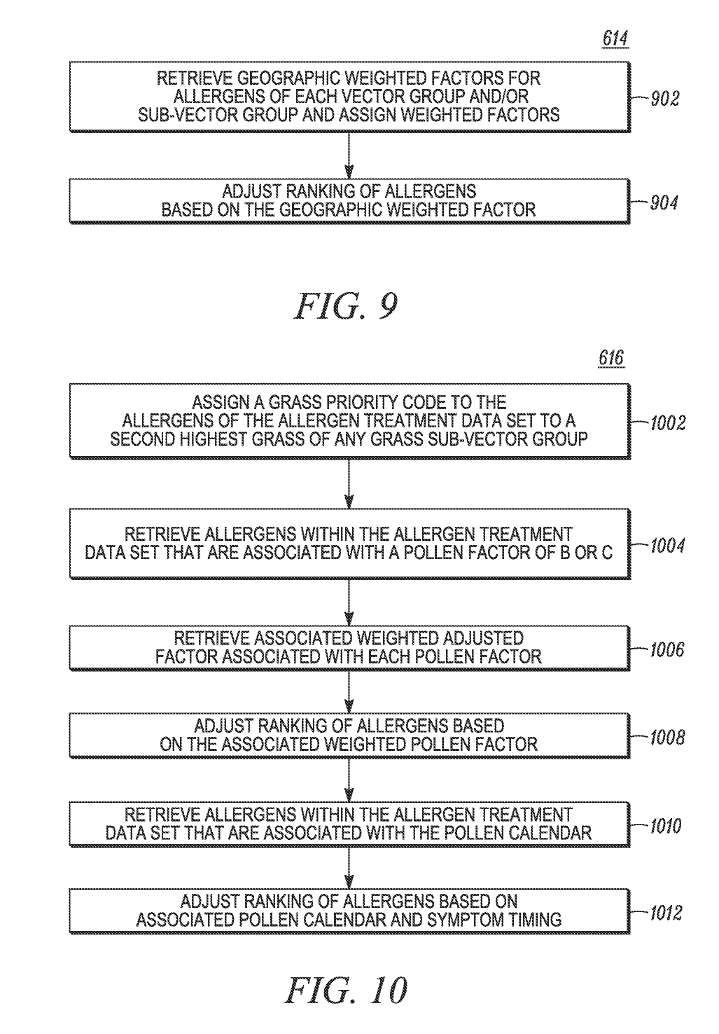

In step 614, the previous ranking or numerical value of allergens within the allergen treatment set is adjusted based on geographical considerations. This is an optional step as these considerations are also taken into account based on allergens. The geographical considerations may include predetermined geographic weighting factors associated with a geographic criterion and/or one or more science factors; thereby the rankings are adjusted based on weighted factors of geographical considerations. FIG. 9 illustrates an exemplary block diagram of adjusting the ranking or numerical value of allergens of an allergen treatment data set conducted with the system based on geographic considerations according to an embodiment of the invention. Referring to FIG. 9, the adjusting ranking step 614 is described with regards to a preferred embodiment in FIG. 9. In step 902, the geographic weighted factors for allergens are obtained from a memory, storage and/or input of the system and compared to the allergen treatment data set with the system 100. If it is determined that there are associated weighted geographic factors for the allergen then go to step 904. The geographic weighted factors include a predetermined numerical value of decreasing or increasing the numerical value associated with one or more geographical or science factors, e.g., altitude, humidity, temperature, location, precipitation, and other factors.

In step 904, the system 100 is configured to adjust the numerical value of allergens in the database from step 612 based on the associated geographic weighted factors. In this embodiment, the adjustment is done by taking the previous adjustment, if any, and adding or subtracting a numerical value associated with the geographic weighting factor. In a preferred embodiment, the numerical value includes, e.g., adding 1 or more, to allergens prevalent in a specific region to allergens affected by the factor as known in the art. This new ranking is stored on the system as the adjusted allergen treatment on the system 100 as done with early embodiments.

In step 616, the previous ranking of the allergens within the allergen treatment data set are adjusted based on other predetermined criteria. FIG. 10 illustrates an exemplary block diagram of adjusting the rank of allergens within an allergen treatment data set with the system based on other predetermined criteria according to an embodiment of the invention. Referring to FIG. 10, the adjusting ranking step 616 is described with regards to a preferred embodiment in FIG. 10. This preferred embodiment is directed towards allergens within Colorado. That is, it is understood that the allergens tested for in the allergy test may vary from location to location or according to other considerations.

In step 1002, the system is configured to assign a green grass allergen priority code to allergens of an allergen treatment data set to a second highest ranked green grass allergen of any grass sub-vector group. This may be done by any device or combination of device, e.g., patient device 108, provider device 106, server, network or combination of the same. In step 1004, a subset of allergens is retrieved from the allergy treatment data set that are associated with a pollen factor. The pollen factor [add definition]. In a preferred embodiment, the pollen factors includes an A pollen factor, a B pollen factor and/or a C pollen factor. It is understood that the pollen factor is only associated within the pollen vector group. A means that there is no pollen weighting factor associated with the associated allergens, B means there is a pollen weighting factor associated with that allergen that would require a slight decrease in ranking or numerical value associated with the associated allergens, and C means there is a pollen weighting factor associated with the associated allergens that would require a moderate decrease in ranking or numerical value.

In step 1006, the system is configured to retrieve the associated allergen weighted adjusted factor associated with each pollen factor. This may be done by any device or combination of devices, e.g., patient device 108, provider device 106, server, network or combination of the same.

In step 1008, the rankings of the allergens associated with a pollen factor are adjusted with system 100, e.g., any device or combination of device, e.g., patient device 108, provider device 106, server, network or combination of the same. In a predetermined adjustment, the retrieved weighting factors, e.g., B and C, are used to adjust the numerical value of each associated allergen based on their respective weighting factor.

In a preferred embodiment, this set of allergens is adjusted by subtracting one or more from their previous numerical value of this subset. It is understood that while these specific allergens are associated with Colorado there may be other allergens that can be adjusted depending on the location of treatment. For example, in other states there may be allergens that should be deprioritized based on allergenicity. Allergenicity is a weighted factor associated with one more allergens as shown in FIGS. 16 and 17. In this embodiment, the allergenicity factors are A, B or C, where A means that there is no allergenicity associated with that allergen, B means there is a allergenicity associated with that allergen that would require a slight decrease in ranking or numerical value associated with the allergen, and C means there is a allergenicity associated with that allergen that would require a moderate decrease in ranking or numerical value associated with the allergen.

In step 1010, the system is configured to retrieve allergens within the allergen treatment data set that are associated with pollen calendar. A pollen calendar is numerical value indicative of one or months corresponding to pollination of the source of the allergen. In one embodiment, any device or combination of devices of the system, e.g., patient device 108, provider device 106, server, network or combination of the same, retrieves the allergens of the allergen treatment data set associated with the pollen calendar. It is understood that the allergens associated with the pollen calendar are in the pollen vector group. In a preferred embodiment, these associated allergens further include a weighting factor configured to add to or subtract from a numerical value for each allergen.

In step 1012, the system is configured to adjust the ranking of allergens based on the associated pollen calendar weighting factor and symptom timing of the patient. That is, when it is determined a patient's symptoms correspond to the pollen calendar then the specific corresponding numerical value of the allergen is adjusted by the weighting factor.

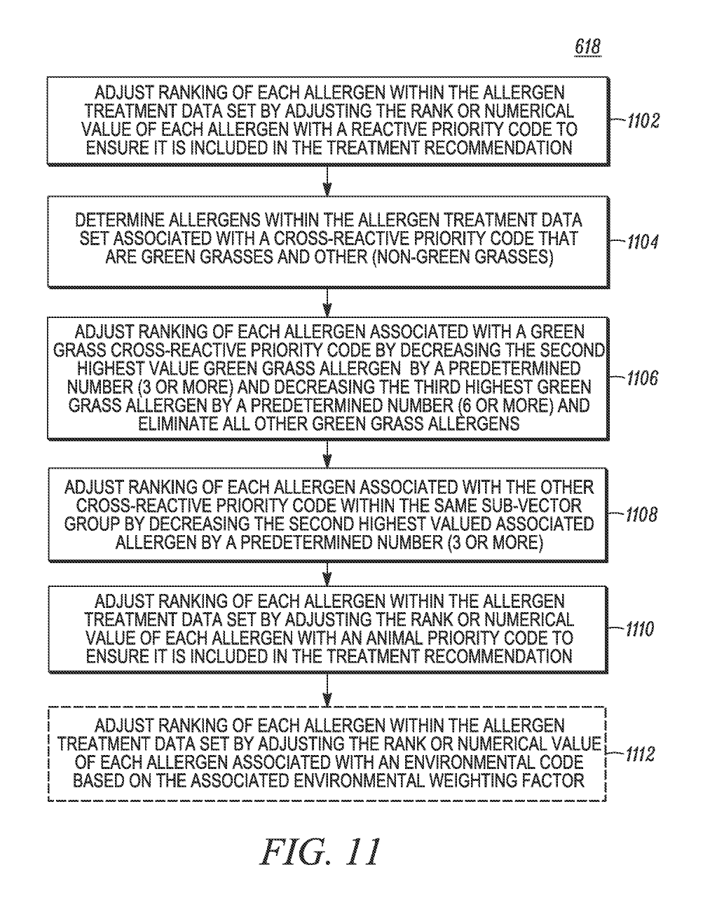

FIG. 11 illustrates an exemplary block diagram of adjusting the ranking of allergens in an allergen treatment data set conducted with the system based on priority codes according to an embodiment of the invention;

Referring to FIG. 11, the adjusting ranking step 618 is described with regards to a preferred embodiment. In step 1102, the system is configured to adjust the ranking or numerical value of each allergen within the allergen treatment data set by adjusting the rank or numerical value of each allergen with a reaction priority code to ensure it is included in the treatment recommendation. The reaction priority code was assigned in step 712. The adjustment is accomplished, e.g., with a processor, by increasing or decreasing the ranking of each allergen associated with a reaction priority code. The reaction priority code has an associated reaction weighting factor that is input or retrieved from storage, e.g., a database. The weighting factor is predetermined and increases or decreases the numerical value of the associated allergen. In a preferred embodiment, the weighting factor increases the numerical value by one or more.

In step 1104, the system is configured to determine allergens within the allergen treatment data set associated with a cross-reactive priority code that are green grasses or other, e.g., non-green, grasses. For example, any device or combination of devices of the system, e.g., patient device 108, provider device 106, server, network or combination of the same, retrieves allergens with this association and stores them to memory.

In step 1106, the system is configured to adjust the ranking or numerical value of each allergen within the allergen treatment data set associated with a green grass cross-reactivity priority code. In one embodiment, an associated weighting factor associated with a green grass cross-reactive priority code is used to decrease the second highest valued green grass allergen by a predetermined number, e.g., 3 or more, decrease the third highest valued green grass allergen by a predetermined number, e.g., 6 or more and eliminate from the allergen treatment data set all other green grass allergens associated with the green grass cross-reactivity priority code.

In step 1108, the numerical value or ranking of each allergen associated with the other cross-reactive priority code within the same sub-vector group is adjusted by the system. The adjustment is done with any device or combination of device of the system, e.g., patient device 108, provider device 106, server, network or combination of the same. In one embodiment, the ranking of associated other allergens are adjusted by decreasing the second highest value associated allergen by a predetermined number, e.g., 3 or more.

In step 1110, the numerical value or ranking of each allergen within the allergen treatment data set associated with an animal priority is adjusted by ensuring the associated allergen is included in the final treatment recommendation. The adjustment is done with any device or combination of devices of the system, e.g., patient device 108, provider device 106, server, network or combination of the same.

In step 1112, which is an optional step, the numerical value or ranking of each allergen within the allergen treatment data set associated with an environmental code are adjusted based on an environmental weighting factor. The adjustment is done with any device or combination of devices of the system, e.g., patient device 108, provider device 106, server, network or combination of the same. The environmental weighting factor may be configured to increase or decrease the value or ranking of the allergens corresponding to symptoms of the patient. For example, the allergens are assigned an indoor or outdoor environmental code, e.g., molds are assigned an indoor environmental code and grasses are assigned an outdoor environmental code. The environmental code is compared to a patient's symptoms occurrence to determine whether the symptoms are more prevalent indoors or outdoors. Should it be determined that the symptoms are more prevalent indoors then an environmental weighting factor is used to increase the value associated within door allergens and/or vice versa.

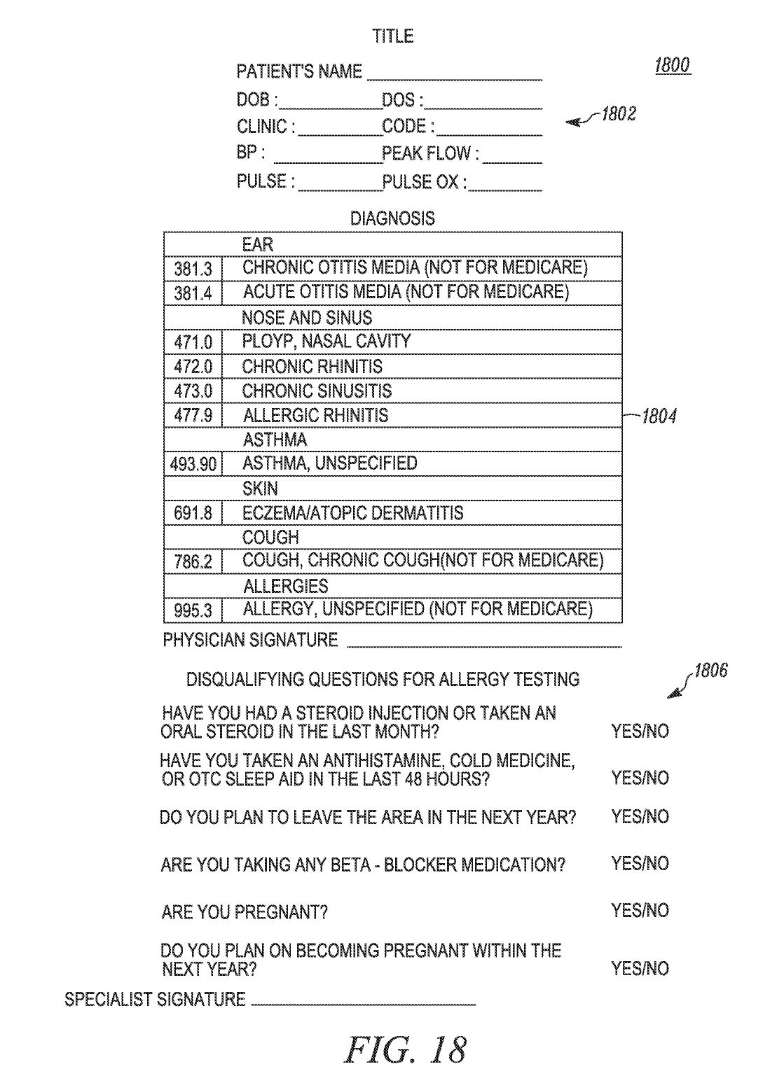

Referring again to FIG. 6, in step 620 a final output treatment recommendation is output to any device or combination of devices of the system, e.g., patient device 108, provider device 106, server, I/O, network or combination of the same. In one embodiment, a treatment recommendation screen shot is shown in FIG. 18.

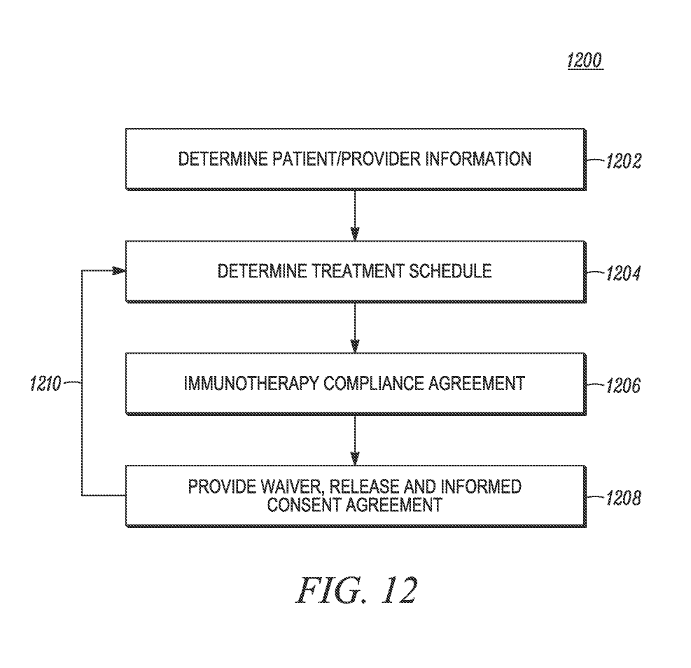

FIG. 12 illustrates an exemplary block diagram of a verification module of the system according to an embodiment of the invention.

Referring to FIG. 12, the verification module is generally shown with reference to number 1200. The verification module 1200 includes a number of processes configured to verify a patient and obtain required authorizations and/or signatures to ensure adequate notice to the patient. In this embodiment, in step 1202, patient and/or provider information is obtained from one or more of a provider device, patient device, network and/or storage. The patient information includes identification of the patient and provider associated with the patient. In step 1204, a treatment schedule is determined or obtained with the system. This determination may include a real time update, adjustment or new treatment schedule. The treatment schedule is an immunotherapy treatment dosage schedule based on the final treatment recommendation. The dosage schedule includes a ramping portion and a maintenance portion. The ramping portion includes increasing dosages or volumes over a predetermined time frame. The treatment schedule may be dynamically adjustable based on adverse effects. Moreover, the schedule is configured to be administrated by a patient, provider or combination of the same. In a preferred embodiment, the schedule is followed by a patient in home based immunotherapy. The schedule is based on the final treatment recommendation and configured to achieve an efficacious immunotherapy treatment schedule with minimized or no adverse effects, e.g., anaphylaxis. In a preferred embodiment, the treatment schedule includes a first schedule including a six week ramp schedule, a second schedule include a six week ramp schedule, a third schedule include a six week ramp schedule, a forth schedule including a six week ramp schedule, a fourth schedule including a six week ramp schedule, and a fifth twenty-six week schedule including a maintenance schedule.

Referring to FIG. 22, an example of Schedule 1 as an illustrative screen shot is generally depicted as number 2200. Schedule 1 is configured be delivered/output to a patient device, I/O and/or provider device with the system and also configured to be dynamic. The screen shot includes a number of editable and retrievable fields, e.g., data fields and or sections. The screen shot 2200 includes a title 2201 indicating the treatment schedule number, a patient name field 2202, a vial identification field 2204, and a concentration field 2206. The vial identification field 2204 correlates to vial identification associated with a treatment recommendation and mixed with allergens indicated in the prescription. The concentration field 2206 includes a concentration of the vial 2204, e.g., 1:5000 dilution, 1:500 dilution, 1:50 dilution, or 1:5 dilution. Of course, other dilutions are possible. Field 2208 includes a dynamically adjustable note section configured to provide warnings, instructions or other criteria to a patient and/or provider.

Section 2212 includes a series of columns assessable by the system to include real time updates and inputs to the patient device, server, and/or provider device. The location/date/time of the device may also be associated with the input to fields in section 2212. Section 2212 includes a week column 2214, a data column 2210, a dosage column 2218, a location column 2220, a remarks column 2222, and an asthmatic column 2224. Section 2212 also includes a physician signature field 2226 and date field 2227. Each column includes one or more data field to receive inputs or outputs into the system. Moreover, each data field may be automatically populated by an associated communication containing relevant data for each field. In a preferred embodiment, the associated communication is from an external injection device. Section 2228 includes a verification statement to be agreed to by a user of the schedule. Section 2230 is a data field configured to a receive a signature or other mark indicative, section 2232 is a date field, and section 2234 is a section in which a printed name may be input.

Schedule 1 is a patient dosage schedule 2200 configured for a predetermined amount of time, e.g., a six week treatment of increased dosage or volume, also called a ramp, over a predetermined time frame at a first concentration (1:5000 dilution). Section 2212 includes a pretreatment step 2236 row; the pretreatment step is utilized prior to starting this treatment schedule in order to reduce adverse reactions. Preferably, the pretreatment is configured as one injection at a dosage or volume configured to prevent any further or next increase from being greater than fifty percent, thereby minimizing or preventing adverse effects such as anaphylaxis. In a preferred embodiment, the dosage or volume of the pretreatment is in a range from about 0.01 ml to about 0.04 ml, and more preferably about 0.04 ml. Next, the schedule includes two treatments per week for six weeks with a ramp as follows: Week 1: shot 1—0.06 mL, 5000 dilution, shot 2—0.09 mL, 5000 dilution; Week 2: shot 1—0.12 mL, 5000 dilution, shot 2—0.15 mL, 5000 dilution; Week 3: shot 1—0.18 mL, 5000 dilution, shot 2—0.21 mL, 5000 dilution; Week 4: shot 1—0.24 mL, 5000 dilution, shot 2—0.27 mL, 5000 dilution; Week 5: shot 1—0.30 mL, 5000 dilution, shot 2—0.33 mL, 5000 dilution; Week 6: shot 1—0.36 mL, 5000 dilution, shot 2—0.39 mL, 5000 dilution.

Schedule 2 (not pictured) includes two treatments per week for six weeks with a ramp as follows: Week 1: shot 1—0.06 mL, 500 dilution, shot 2—0.09 mL, 500 dilution; Week 2: shot 1—0.12 mL, 500 dilution, shot 2—0.15 mL, 500 dilution; Week 3: shot 1—0.18 mL, 500 dilution, shot 2—0.21 mL, 500 dilution; Week 4: shot 1—0.24 mL, 500 dilution, shot 2—0.27 mL, 500 dilution; Week 5: shot 1—0.30 mL, 500 dilution, shot 2 —0.33 mL, 500 dilution; Week 6: shot 1—0.36 mL, 500 dilution, shot 2—0.39 mL, 500 dilution.

Schedule 3 (not pictured) includes two treatments per week for six weeks with a ramp as follows: Week 1: shot 1—0.06 mL, 50 dilution, shot 2—0.09 mL, 50 dilution; Week 2: shot 1—0.12 mL, 50 dilution, shot 2—0.15 mL, 50 dilution; Week 3: shot 1—0.18 mL, 50 dilution, shot 2—0.21 mL, 50 dilution; Week 4: shot 1—0.24 mL, 50 dilution, shot 2 —0.27 mL, 50 dilution; Week 5: shot 1—0.30 mL, 50 dilution, shot 2—0.33 mL, 50 dilution; Week 6: shot 1—0.36 mL, 50 dilution, shot 2—0.39 mL, 50 dilution.

Schedule 4 (not pictured) includes two treatments per week for six weeks with a ramp as follows: Week 1: shot 1—0.06 mL, 5 dilution, shot 2—0.09 mL, 5 dilution; Week 2: shot 1—0.12 mL, 5 dilution, shot 2—0.15 mL, 5 dilution; Week 3: shot 1—0.18 mL, 5 dilution, shot 2—0.21 mL, 5 dilution; Week 4: shot 1—0.24 mL, 5 dilution, shot 2—0.27 mL, 5 dilution; Week 5: shot 1—0.30 mL, 5 dilution, shot 2—0.33 mL, 5 dilution; Week 6: shot 1—0.36 mL, 5 dilution, shot 2—0.39 mL, 5 dilution.

Schedule 5 (not pictured) includes two treatments per week for twenty-six weeks as a maintenance schedule as follows: Weeks 1 through 26 or more: shot 1—0.30 mL, 5 dilution, shot 2—0.30 mL, 5 dilution per each week.

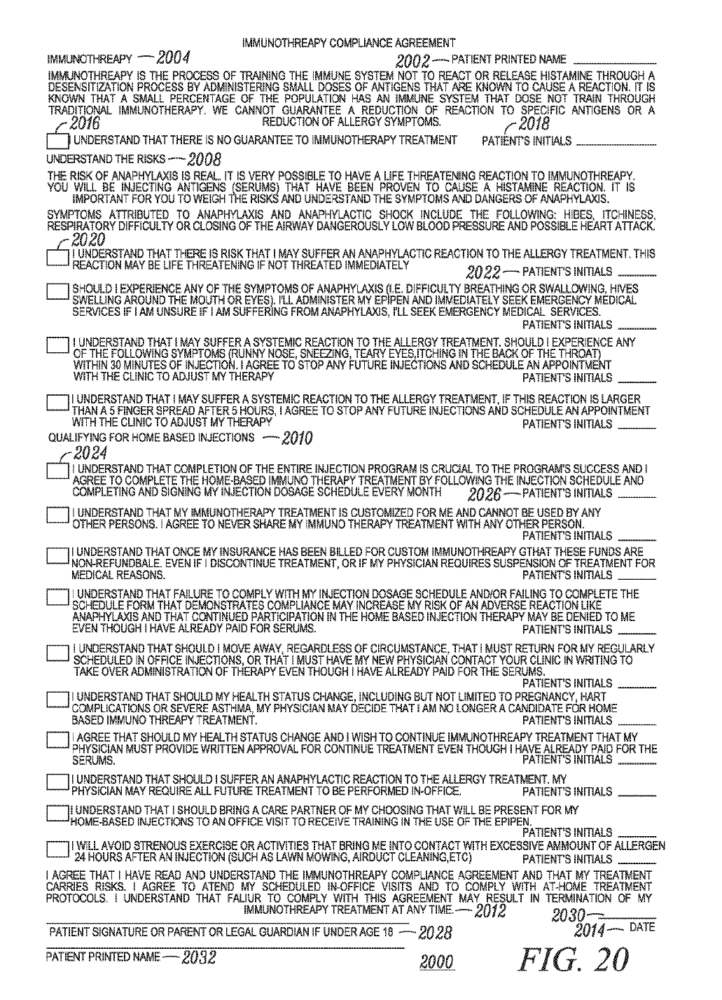

In step 1206, a compliance agreement is output to one or more of a provider device, patient device, I/O or other device to a user. The compliance agreement is an agreement between the patient and provider configured to increase efficacious, provider risks to the patient with the treatment and/or provide other legal notifications to a patient. FIG. 20 illustrates an exemplary screen shot of a patient compliance agreement screen according to an embodiment of the invention.

Referring to FIG. 20, the agreement is generally depicted with reference to number 2000. The screen shot includes a plurality of fields configured to receive and/or dynamically change including a patient identifier field 2002, summary section 2004, understanding risks section 2008, qualifying section 2010, agreement section 2012, and patient acceptance section 2014. Each section also includes fillable and/or selected fields configured to indicate acceptance and/or notice of each section. These fields may also be associated with a specific device, treatment schedule, date stamp, time stamp and location.

The patient identifier field 2002 includes a name of a patient and/or other associated criteria of a patient, e.g., device identification, associated patient number and the like. The summary section 2004 includes a general section configured to not guarantee results of the immunotherapy treatment and one or more acceptance fields 2016 and 2018. In this embodiment, the acceptance field 2016 is fillable and acceptance field 2018 requires an active input, e.g., initials.

The understanding the risks section 2008 includes a general section configured to communicate standard and known risks associated with immunotherapy and one or more acceptance fields 2020 and 2022. In this embodiment, the acceptance field 2020 is fillable and acceptance field 2022 requires an active input, e.g., initials. Each subsection may have acceptance fields (not labeled).

The qualification section 2010 includes a general section configured to communicate standard qualifications statements associated with whether a patient is eligible for immunotherapy and one or more acceptance fields 2024 and 2026. In this embodiment, the acceptance field 2024 is fillable and acceptance field 2026 requires an active input, e.g., initials. Each subsection may have acceptance fields (not labeled).

The agreement section 2012 includes a legal statement for the patient. The acceptance section 2014 includes one or more acceptance field 2028 for obtaining a patient signature or mark, a date field 2030 and a printed name field 2032. The sections and this agreement are configured to be compliant with standard electronic signature requirements as known in the art. This agreement is then saved on the system, e.g., memory, and optionally utilized to trigger another process or module herein. The agreement 2000 can be supplied to a patient device prior to any new output treatment schedule, treatment, or at any other time.

In step 1208, a waiver, release and informed consent agreement is output to one or more of a provider device, patient device, I/O or other device to a user. The agreement is an agreement between the patient and provider configured to provide a requisite legal waiver, release and/or informed consent based on federal and/or state law. This step and agreement can be combined with step 1206 and agreement 2000 and/or obtained manually. This is also true for agreement 2000 which can be obtained manually or by other means.

FIG. 21 illustrates an exemplary screen shot of a patient waiver and release form according to an embodiment of the invention.

Referring to FIG. 21, the patient waiver and release form is generally depicted with reference to number 2100. The screen shot includes a plurality of fields configured to receive and/or be dynamically changeable including a patient identifier field 2102, provider identifier field 2104, one or more agreement clauses 2106, and a patient acceptance section 2108. Each section also includes fillable and/or selected fields configured to indicate acceptance and/or notice of each section similar to those described with reference to FIG. 20. These fields may also be associated with a specific device, treatment schedule, date stamp, time stamp and location.

The patient identifier field 2102 includes a name of a patient and/or other associated criteria of a patient, e.g., device identification, associated patient number and the like. The provider identifier field 2104 includes a name of a provider and/or other associated criteria of a provider, e.g., device identification, associated provider number and the like. The acceptance section 2108 includes one or more acceptance field for obtaining a patient signature or mark 2110, a date field 2112, a parent or legal guardian section 2114 and a printed name field 2116. In addition, other schedule treatment notification fields are shown as schedule 1 field 2118, schedule 2 field 2120, schedule 3 field 2122, schedule 4 field 2124, and optionally a maintenance schedule field (not shown). These acceptance fields are configured to be compliant with standard electronic signature requirements as known in the art. This agreement is then saved on the system, e.g., memory, and optionally utilized to trigger another process or module herein. The agreement 2100 can be supplied to a patient device prior to any new output treatment schedule, treatment, or at any other time. The process is also repeatable for the next schedule as shown in step 1210.

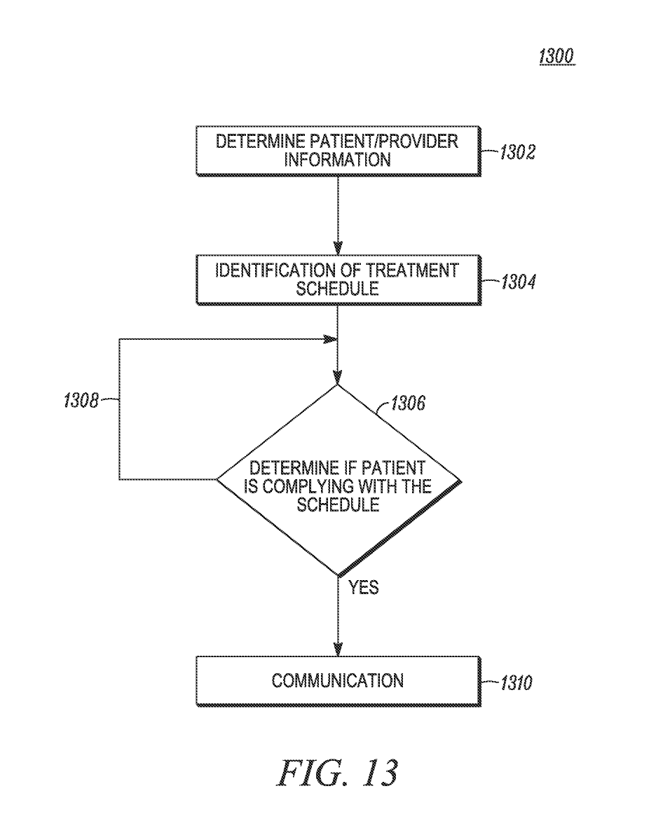

FIG. 13 illustrates an exemplary block diagram of a compliance module conducted with the system according to an embodiment of the invention.

Referring to FIG. 13, a compliance module is generally depicted with reference to number 1300. The module 1300 is configured to determine whether a patient is compliant with a treatment schedule as described herein. This is an optional module that may be implemented by a provider and manually, and/or automatically monitored by a provider. In one embodiment, when a patient is not compliant an electronic communication, e.g., SMS, email, phone call, or other, is generated and sent to a provider, patient, guardian, and/or third party. In one embodiment, the communication is configured temporally to the non-compliance to aid a patient's compliance and increase ultimate effectiveness of treatment.

In step 1302, the system is configured to determine patient and provider information from storage, e.g., database. This module and/or determining step may be in response to a recent treatment, lack of treatment or other criteria. Based on at least patient information and other relevant criteria a treatment schedule is obtained (step 1304). In step 1306, it is determined whether the treatment schedule is being followed properly. If it is being followed properly then a predetermined amount of time is waited and step 1306 is repeated. If it is not being followed, step 1310 is done and the alerts are sent. In addition, should it be determined that the schedule is not being followed a real-time update of a new schedule may be provided. The new schedule would automatically adjust for non-compliance.

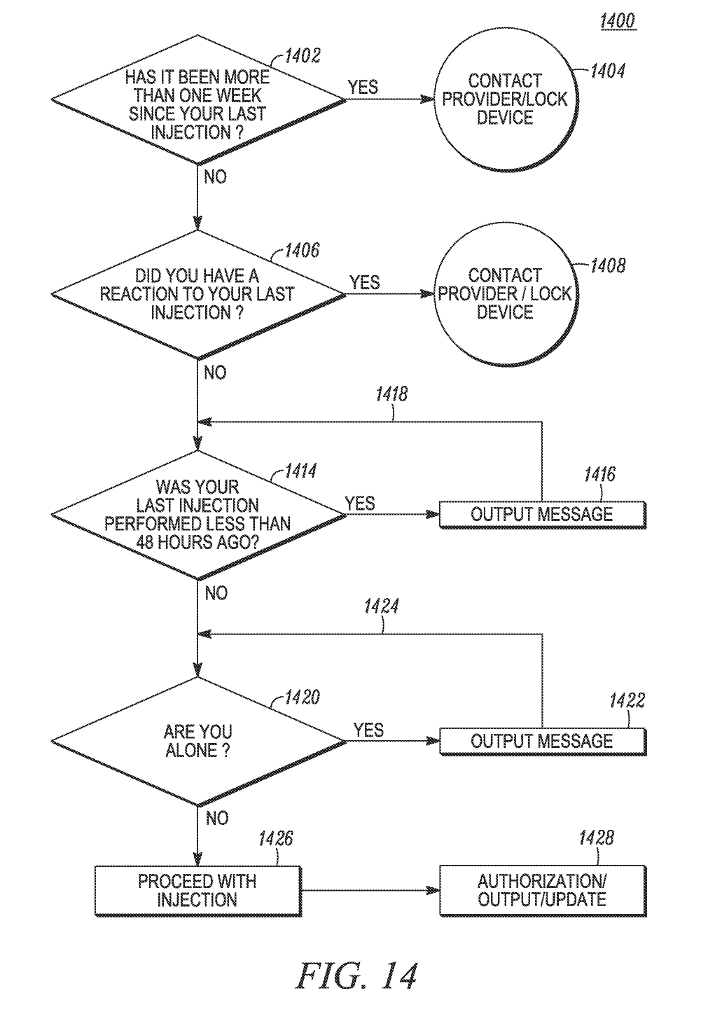

FIG. 14 illustrates an exemplary block diagram of an injection module associated with a specific treatment conducted with the system according to an embodiment of the invention.

Referring to FIG. 14, the injection module is generally depicted with reference to number 1400. Optionally, this embodiment is associated with an injection device. In this embodiment, the questions are configured to be delivered to a patient device and/or provider device contemporaneous with a desired injection with the system. In step 1402, a question is presented as to whether it has been more than one week since a patient's last injection. This question is followed with an acceptance field and the input is received. The received input in response to the question is analyzed to determine whether there is a yes or no answer. If yes, then go to step 1404, if not then go to step 1406.

In step 1404, the system is configured to send an alert, communication or by other means to a provider. In one embodiment, the alert is an electronic communication, e.g., SMS, email, phone call, or other, is generated and sent to a provider, patient, guardian, and/or third party. In one embodiment, the communication is configured temporally to the non-compliance to aid a patient's compliance and increase the ultimate effectiveness of treatment. Optionally, and/or alternatively, the treatment schedule can be updated or the provider can provide an override code to the user or override the system to go to step 1406. Optionally, the alert also includes another communication configured to deactivate the injection device. The injection device can be reactivated with a provider override or override code.

In step 1406, a question is presented as to whether a reaction resulted in response to the last injection. This question is followed with an acceptance field and the input is received. The received input in response to the question is analyzed to determine whether there is a yes or no answer. If yes, then go to step 1408, if not then go to step 1410.

In step 1408, the system is configured to send an alert or communication by electronic or other means to a provider. In one embodiment, the alert is an electronic communication, e.g., SMS, email, phone call, or other, is generated and sent to a provider, patient, guardian, and/or patient. In one embodiment, the communication is configured temporally to the non-compliance to aid a patient's compliance and increase the ultimate effectiveness of treatment. Optionally, and/or alternatively, the treatment schedule can be updated the provider can provide an override code to the user or override the system to go to step 1410. Optionally, the alert also includes another communication configured to deactivate the injection device. The injection device can be reactivated with a provider override or override code.

In step 1414, a question is presented as to whether it has been less than 48 hrs. since the last injection. This question is followed with an acceptance field and the input is received. The received input in response to the question is analyzed to determine whether there is a yes or no answer. If yes, then go to step 1416, if no then go to step 1420.

In step 1416, the system is configured to send an alert or communication by electronic or other means to the user. The communication includes a message to wait the required 48 hours and step 1414 is repeated with step 1418.

In step 1420, a question is presented as to whether a user is alone. This question is followed with an acceptance field and the input is received. The received input in response to the question is analyzed to determine whether there is a yes or no answer. If yes, then go to step 1422, if not then go to step 1426.

In step 1422, the system is configured to send an alert or communication by electronic or other means to the user. The communication includes a message to wait until the patient's immunotherapy partner or other individual trained in the use of the Epi-Pen is present.

In step 1426, the system is configured to send an alert, communication or by other means to the user. The communication includes a message to proceed with injection.

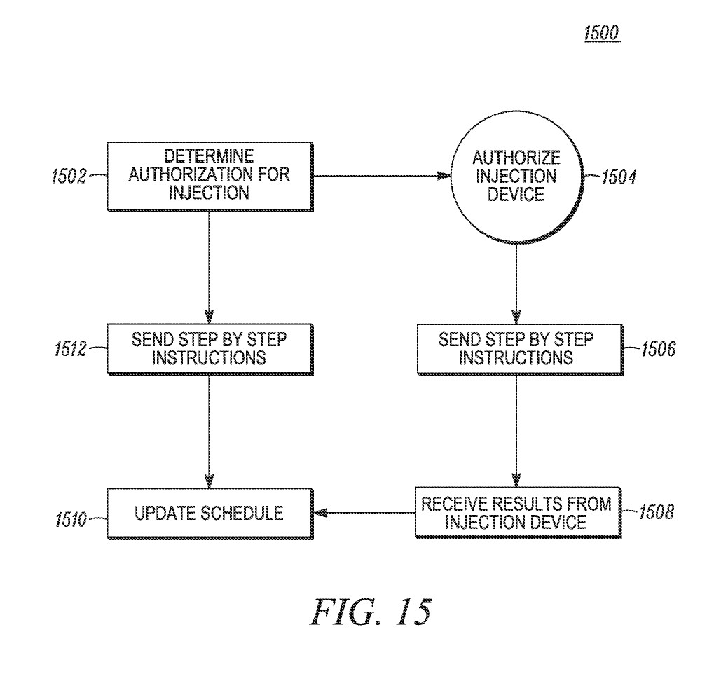

In step 1428, an optional authorization, output and/or update module 1500 is activated. FIG. 15 illustrates an exemplary block diagram of an authorization, output and/or update module conducted with the system according to an embodiment of the invention.

Referring to FIG. 15, the module 1500 is conducted with system as software or hardware and includes determining authorization for injection (step 1502). In step 1502, it is determined whether verification module 1200 has been administered and satisfied. To determine whether satisfied the treatment schedule is compared with agreements of step 1206 and 1208 to determine whether appropriate electronic signatures or other acceptance by the user has been satisfied. If not satisfied the verification module 1200 is conducted, if satisfied and the user is using an injection device associated with the system go to step 1504. In step 1504, the injection device is authorized with a communication, e.g., a wireless communication from the patient device and/or provider device. If no injection is utilized go to step 1512.

Steps 1512 and 1506 are the same and include step by step instructions for either the provider or the patient for administering the injection. These instructions can be coupled with a photograph and sent either to the provider device or patient device with the system. Next, in step 1508, results are communicated, e.g., wirelessly, from the injection device to the system. The results include information indicative of one or more of time of injection, dosage, concentration, date, orientation, and the like. In step 1510, the schedule is automatically or manually updated.

FIG. 16 illustrates an exemplary screen shot of allergy test information prior to receiving results according to an embodiment of the invention.

Referring to FIG. 16, the screen shot is generally depicted as reference number 1600. The allergy test form includes a plurality of sections with fillable and/or selectable fields. These fields may also be associated with a specific device, treatment schedule, date stamp, time stamp, patient, provider, location and combination of the same.

In this embodiment, there are sixty allergens 1-60 that were used in a test on a patient. Each allergen also includes an associated manufacturer code 1603, e.g., a four digit code, pollen calendar code 1605, pollen factor code 1607 and cross-reactivity code 1609. The pollen calendar code 1605 includes a month or months, e.g., 5-8, in which there is associated pollination of pollen producing species associated with the allergen.

In this embodiment, the cross-reactivity code 1609 is a code that indicates cross-reactivity of allergens within the same sub-vector group and in this embodiment includes a letter and color. Accordingly, the allergens with the same code 1609 within the same sub-vector group are cross reactive. It is noted that the specific allergens to be tested with the patient may be adjusted and also vary from region to region or other factors, e.g., patient specific factors, as known in the art. These listed allergens have been found to be effective for the Colorado region. This form includes region field 1602, a patient identification field 1604, date of birth field 1606, sex field 1608, blood pressure field 1610, pulse field 1612, clinic identification field 1614, test date field 1616, a pollen vector group field 1618, animal vector group field 1620, environmental group field 1622, and control vector group field 1624. The pollen vector group field 1618 includes a tree sub-vector group field 1626, a grass sub-vector group field 1628, a weed sub-vector group field 1630. The animal vector group includes an indoor animal sub-vector group and an outdoor animal sub-vector group. The control vector group includes a saline control sub-vector group and histamine control sub-vector group. This form also includes a test ranking section adjacent to each allergen 1642; a numerical value is input in this field after a test which is indicative of a reaction to the allergy test. In a preferred embodiment, the allergy test results are input into this form with a user or provider device based on results of an in vivo test, e.g., numerical values based on one or more of an actual size of a wheal diameter as a response to one or more allergens as known in the art.

The form 1600 further includes a diagnosis section 1632, prescription section 1634, season ranking section 1636, patient authorization section 1638 and physician authorization section 1640.

The diagnosis section 1632 includes one more diagnosis and associated codes, e.g., international classification of diseases code, such as a ICD9 code, a ICD10 or other medical codes. The prescription section 1634 includes a number of fields for listing allergens to be treated for and is configured as a prescription; thereby a patient or user can fill the prescription to obtain a desired immunotherapy treatment set. The number and ranking of allergens is generated with the generate treatment module 420. The season ranking section 1636 includes a field to add a ranking associated with a patient's associated worst symptom, second worse symptoms and so on.

The patient authorization section 1638 includes a data field configured to a receive a signature or other mark indicative of acceptance from a patient and/or technician and associated date field. The physician authorization section 1640 includes a data field configured to a receive a signature or other mark indicative of acceptance from a provider and/or technician and associated date field.

FIG. 17 illustrates an exemplary screen shot of a final allergy treatment recommendation according to an embodiment of the invention.

Referring to FIG. 17, the screen shot 1700 is generated with module 1420 and includes the same fields described with reference to FIG. 16. The fields have been populated by the system. The prescription section 1634 includes a first allergen 1704, a second allergen 1706, a third allergen 1708, a forth allergen 1710 and fifth allergen 1712. The allergens are utilized by a patient or user to fill the prescription to obtain a desired treatment set of immunotherapy. These allergens in the prescription are generated with the generate treatment module 420 by adjusting the ranking of the numerical value associated with the allergy test. Column 1714, the adjusted ranking column, is utilized so a provider can visualize the original ranking of allergens 1642 in the allergen treatment data set based on the test results with the adjusted rankings 1714. The season ranking section 1636 includes a field 1720 associated with a season in which a patient had their worst symptoms, a field 1722 associated with a season in which a patient had their second worst symptoms and a field 1722 associated with a season in which a patient had their third worst symptoms.

The diagnosis section 1632 includes one more diagnosis and associated code, e.g., international classification of diseases code, such as a ICD9 code, a ICD10 or other medical codes.

FIG. 18 illustrates an exemplary screen shot of a patient diagnosis form including an allergy questionnaire screen according to an embodiment of the invention.

Referring to FIG. 18, the patient diagnosis form is generally depicted with reference to number 1800. This is merely an exemplary form and can include more or fewer questions configured to obtain a diagnosis. The screen shot includes a plurality of fields configured to receive and/or be dynamically changeable including a patient identifier section 1802, diagnosis section 1804, and disqualifying section 1806. Each section also includes fillable and/or selected fields configured to indicate acceptance and/or notice of each section similar to those described with reference to FIG. 20. These fields may also be associated with a specific device, treatment schedule, date stamp, time stamp and location.

The patient identifier section 1802 includes a name of a patient and/or other associated criteria of a patient, e.g., device identification, associated patient number and the like, date of birth of patient field, date of service field, clinic identifier field, code field, blood pressure field, peak flow field, pulse field, pulse Ox field. Each of the fields are fillable or selectable as described herein. The diagnosis section 1804 includes specific codes and associated diagnosis. The codes may include any medical classification codes as known in the art. Again, each of the fields are fillable or selectable as described herein. The disqualifying section 1806 includes one more questions configured to disqualify a patient for treatment. Again, each of the fields are fillable or selectable as described herein.

FIG. 19 illustrates an exemplary screen shot of an allergy questionnaire form according to an embodiment of the invention;

Referring to FIG. 19, the form is generally depicted with reference to number 1900. The form is merely an exemplary form and can include more or fewer questions configured to obtain a diagnosis and further refine a treatment recommendation. The screen shot includes a plurality of fields, e.g., fillable and/or selected fields configured to indicate acceptance each question or response. These fields may also be associated with a specific device, treatment schedule, date stamp, time stamp, patient, provider and location.

While various embodiments of the present disclosure have been described in detail, it is apparent that modifications and alterations of those embodiments will occur to those skilled in the art. However, it is to be expressly understood that such modifications and alterations are within the scope and spirit of the present disclosure, as set forth in the following claims.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover, though the present disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

1.-17. (canceled)

18. A system for generating a patient specific immunotherapy treatment recommendation, comprising:
a network interface configured to receive a first input comprising information having characteristics indicative of a patient medical history, a second input comprising information having characteristics indicative of one or more of science factors, and a third input comprising information having characteristics indicative a patient's immune response to one or more antigens of a test; and
a processor configured to process the first input, the second input and the third input to programically deduce an immunotherapy treatment recommendation.

19. A system for managing immunotherapy, comprising:
a computational equipment comprising at least one processor and at least one memory, wherein the at least one processor and the at least one memory are communicatively arranged to:
generate an immunotherapy treatment recommendation from one or more inputs received from a provider device comprising at least one processor and at least one memory;
provide the immunotherapy treatment recommendation to the provider device; and
receive a verification of the immunotherapy treatment recommendation from the provider device.

20. The system of claim 19, wherein the at least one processor and the at least one memory are communicatively arranged to:
provide a diagnosis criteria to the provider device; and
receive the diagnosis criteria from provider device.

21. (canceled)

22. The system of claim 20, wherein the one or more inputs comprises data associated with an allergy questionnaire and data associated with an allergy test.

23. The system of claim 22, wherein the data associated with an allergy test and allergy questionnaire comprises information indicative of one or more of pollination characteristics, patient treatment preferences, geography, and seasonality.

24. The system of claim 22, wherein the data associated with allergy questionnaire comprises information indicative of one or more of patient characteristics, patient name, patient insurance information, patient occupation, patient symptoms, patient treatment preferences, patient hobbies, qualifying diagnosis, international classification of diseases (ICD) codes, current medications, and clinician notes.

25-27. (canceled)

28. The system of claim 19, wherein the immunotherapy treatment recommendation comprises one or more allergens of an allergen treatment data set classified in one or more specific vector groups, the specific vector groups comprises or more of a pollen vector group and an environmental vector group, animal vector group and a control vector group.

29-34. (canceled)

35. The system of claim 19, wherein the treatment recommendation comprises a cross-reactive designation of one or more allergens in of a sub-vector group that are cross-reactive with one or more of the allergens in the same sub-vector group.

36. The system of claim 35, wherein the cross-reactive designation comprises one or more of a color code and alphanumerical code.

37. The system of claim 19, wherein the immunotherapy treatment recommendation comprises a listing of allergens of an allergen treatment data set organized in numerical rank order, wherein the numerical rank order comprises assigning each allergen an integer value in a range from 1 to 100.

38. The system of claim 37, wherein the one or more of the allergens comprises the same numerical rank order.

39. The system of claim 19, wherein the immunotherapy treatment recommendation comprises at least one allergen for treatment.

40. The system of claim 19, wherein the immunotherapy treatment recommendation comprises at least five different allergens indicated for treatment.

41. (canceled)

42. The system of claim 19, wherein the immunotherapy treatment recommendation comprises allergens ranked in a treatment set order configured to be displayed on the provider device with allergens of the treatment set order arranged in predetermined locations of the display based upon a vector group and sub-vector group.

43. (canceled)

44. An immunotherapy system for generating an immunotherapy treatment recommendation, comprising:
computational equipment
configured to generate the immunotherapy treatment recommendation based on a first input comprising one more characteristics indicative of a patient medical history, a second input comprising one or more characteristics indicative of one or more science factors, and a third input comprising one or more characteristics indicative of patient's immune response to one or more antigens of an immune response test.

45. The system of claim 44, wherein the system is configured to provide the treatment recommendation to a provider device, wherein the provider device and computation equipment are at different locations.

46. The system of claim 44, wherein the provider device comprises a mobile device.

47. The system of claim 44, wherein the computation equipment resides on a mobile device.

48.-59. (canceled)

60. The system of claim 44, wherein the computation device resides on a network.

61. The system of claim 44, wherein the computation equipment at least partially resides on a cloud and mobile device.
